(19) United States
(12) Patent Application Publication
(10) Pub. No.: US 2024/0372154 A1
(43) Pub. Date: Nov. 7, 2024

(54) SECONDARY BATTERY, BATTERY PACK, ELECTRONIC EQUIPMENT, ELECTRIC TOOL, ELECTRIC AIRCRAFT, AND ELECTRIC VEHICLE

(71) Applicant: MURATA MANUFACTURING CO., LTD., Kyoto (JP)

(72) Inventor: Yoshinori WAKUI, Kyoto (JP)

(21) Appl. No.: 18/775,262

(22) Filed: Jul. 17, 2024

Related U.S. Application Data
(63) Continuation of application No. PCT/JP2023/009127, filed on Mar. 9, 2023.

(30) Foreign Application Priority Data
Mar. 14, 2022 (JP) 2022-039351

(51) Int. Cl. H01M 10/0587; B25F 5/00; B60L 50/60; B64D 27/357; B64D 31/16; H01M 4/02; H01M 4/133; H01M 4/36; H01M 4/48; H01M 4/587; H01M 50/107; H01M 50/417

(52) U.S. Cl. CPC H01M 10/0587; B60L 50/60; B64D 27/357; B64D 31/16; H01M 4/133; H01M 4/364; H01M 4/48; H01M 4/587; H01M 50/107; H01M 50/417; B25F 5/00; B60L 2200/10; H01M 2004/027; H01M 2220/20; H01M 2220/30

(57) ABSTRACT

A secondary battery includes an electrode wound body, a first electrode current collector plate, a second electrode current collector plate, an electrolytic solution, and a battery can. The first electrode current collector plate faces a first end face of the electrode wound body. The second electrode current collector plate faces a second end face of the electrode wound body. In the electrode wound body, an outermost wind part of a second electrode is located on an outer side relative to an outermost wind part of a first electrode. A sidewall part of the battery can includes a thin part, and a thick part that protrudes toward an inner side of the battery can along a radial direction. The thick part is located to overlap, in the radial direction, an end part, of the first electrode covered part, located on a side of the first end face in the first direction.

### CROSS-REFERENCE TO RELATED APPLICATIONS

The present application is a continuation of International Application No. PCT/JP2023/009127, filed on Mar. 9, 2023, which claims priority from Japanese Patent Application No. 2022-039351, filed on Mar. 14, 2022, the entire contents of which are hereby incorporated by reference.

### BACKGROUND

The present disclosure relates to a secondary battery, and to a battery pack, electronic equipment, an electric tool, an electric aircraft, and an electric vehicle that each include the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a secondary battery is proposed in which what is called a tabless structure is employed. Such a secondary battery achieves a reduced internal resistance and allows for charging and discharging with a relatively large current.

### SUMMARY

The present disclosure relates to a secondary battery, and to a battery pack, electronic equipment, an electric tool, an electric aircraft, and an electric vehicle that each include the secondary battery.

A secondary battery according to an embodiment of the present disclosure includes an electrode wound body, a first electrode current collector plate, a second electrode current collector plate, an electrolytic solution, and a battery can. The electrode wound body includes a stacked structure wound around a central axis extending in a first direction. The stacked structure includes a first electrode and a second electrode that are stacked with a separator interposed between the first electrode and the second electrode. The first electrode current collector plate is disposed to face a first end face of the electrode wound body, the first end face being in the first direction. The second electrode current collector plate is disposed to face a second end face of the electrode wound body. The second end face is opposite to the first end face in the first direction. The battery can includes a bottom part and a sidewall part, and contains the electrode wound body, the first electrode current collector plate, the second electrode current collector plate, and the electrolytic solution. The bottom part of the battery can is opposed to the second end face with the second electrode current collector plate interposed between the bottom part and the second end face. The sidewall part of the battery can stands on the bottom part to surround the electrode wound body. The first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate. The second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate. In the electrode wound body, an outermost wind part of the second electrode is located on an outer side relative to an outermost wind part of the first electrode. The sidewall part of the battery can includes a thin part and a thick part. The thick part protrudes toward an inner side of the battery can along a radial direction of the electrode wound body, the radial direction being orthogonal to the first direction. The thick part is located to overlap, in the radial direction, an end part of the first electrode covered part, the end part being located on a side of the first end face in the first direction.

A battery pack according to an embodiment of the present disclosure includes a secondary battery, a processor configured to control the secondary battery, and an outer package body containing the secondary battery. The secondary battery includes an electrode wound body, a first electrode current collector plate, a second electrode current collector plate, an electrolytic solution, and a battery can. The electrode wound body includes a stacked structure wound around a central axis extending in a first direction. The stacked structure includes a first electrode and a second electrode that are stacked with a separator interposed between the first electrode and the second electrode. The first electrode current collector plate is disposed to face a first end face of the electrode wound body, the first end face being in the first direction. The second electrode current collector plate is disposed to face a second end face of the electrode wound body. The second end face is opposite to the first end face in the first direction. The battery can includes a bottom part and a sidewall part, and contains the electrode wound body, the first electrode current collector plate, the second electrode current collector plate, and the electrolytic solution. The bottom part of the battery can is opposed to the second end face with the second electrode current collector plate interposed between the bottom part and the second end face. The sidewall part of the battery can stands on the bottom part to surround the electrode wound body. The first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate. The second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate. In the electrode wound body, an outermost wind part of the second electrode is located on an outer side relative to an outermost wind part of the first electrode. The sidewall part of the battery can includes a thin part and a thick part. The thick part protrudes toward an inner side of the battery can along a radial direction of the electrode wound body, the radial direction being orthogonal to the first direction. The thick part is located to overlap, in the radial direction, an end part of the first electrode covered part, the end part being located on a side of the first end face in the first direction.

An electric vehicle according to an embodiment of the present disclosure includes a secondary battery, a converter, a drive unit, and a processor. The secondary battery includes an electrode wound body, a first electrode current collector plate, a second electrode current collector plate, an electrolytic solution, and a battery can. The electrode wound body includes a stacked structure wound around a central axis extending in a first direction. The stacked structure includes a first electrode and a second electrode that are stacked with a separator interposed between the first electrode and the second electrode. The first electrode current collector plate is disposed to face a first end face of the electrode wound body, the first end face being in the first direction. The second electrode current collector plate is disposed to face a second end face of the electrode wound body. The second end face is opposite to the first end face in the first direction. The battery can includes a bottom part and a sidewall part, and contains the electrode wound body, the first electrode current collector plate, the second electrode current collector plate, and the electrolytic solution. The bottom part of the battery can is opposed to the second end face with the second electrode current collector plate interposed between the bottom part and the second end face. The sidewall part of the battery can stands on the bottom part to surround the electrode wound body. The first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate. The second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate. In the electrode wound body, an outermost wind part of the second electrode is located on an outer side relative to an outermost wind part of the first electrode. The sidewall part of the battery can includes a thin part and a thick part. The thick part protrudes toward an inner side of the battery can along a radial direction of the electrode wound body, the radial direction being orthogonal to the first direction. The thick part is located to overlap, in the radial direction, an end part of the first electrode covered part, the end part being located on a side of the first end face in the first direction. The converter is configured to convert electric power suppled from the secondary battery into a driving force. The drive unit is configured to perform driving in accordance with the driving force. The processor is configured to control operation of the secondary battery.

An electric aircraft according to an embodiment of the present disclosure includes a battery pack, rotary wings, a motor, a support shaft, a motor control processor, and an electric power supply line. The battery pack includes a secondary battery, a processor configured to control the secondary battery, and an outer package body containing the secondary battery. The secondary battery includes an electrode wound body, a first electrode current collector plate, a second electrode current collector plate, an electrolytic solution, and a battery can. The electrode wound body includes a stacked structure wound around a central axis extending in a first direction. The stacked structure includes a first electrode and a second electrode that are stacked with a separator interposed between the first electrode and the second electrode. The first electrode current collector plate is disposed to face a first end face of the electrode wound body, the first end face being in the first direction. The second electrode current collector plate is disposed to face a second end face of the electrode wound body. The second end face is opposite to the first end face in the first direction. The battery can includes a bottom part and a sidewall part, and contains the electrode wound body, the first electrode current collector plate, the second electrode current collector plate, and the electrolytic solution. The bottom part of the battery can is opposed to the second end face with the second electrode current collector plate interposed between the bottom part and the second end face. The sidewall part of the battery can stands on the bottom part to surround the electrode wound body. The first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate. The second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate. In the electrode wound body, an outermost wind part of the second electrode is located on an outer side relative to an outermost wind part of the first electrode. The sidewall part of the battery can includes a thin part and a thick part. The thick part protrudes toward an inner side of the battery can along a radial direction of the electrode wound body, the radial direction being orthogonal to the first direction. The thick part is located to overlap, in the radial direction, an end part of the first electrode covered part, the end part being located on a side of the first end face in the first direction. The motor is configured to rotate each of the rotary wings. The support shaft supports each of the rotary wings and the motor. The motor control processor is configured to control rotation of the motor. The electric power supply line is configured to supply electric power to the motor. The battery pack is coupled to the electric power supply line.

An electric tool according to an embodiment of the present disclosure includes a secondary battery and a movable part. The secondary battery includes an electrode wound body, a first electrode current collector plate, a second electrode current collector plate, an electrolytic solution, and a battery can. The electrode wound body includes a stacked structure wound around a central axis extending in a first direction. The stacked structure includes a first electrode and a second electrode that are stacked with a separator interposed between the first electrode and the second electrode. The first electrode current collector plate is disposed to face a first end face of the electrode wound body, the first end face being in the first direction. The second electrode current collector plate is disposed to face a second end face of the electrode wound body. The second end face is opposite to the first end face in the first direction. The battery can includes a bottom part and a sidewall part, and contains the electrode wound body, the first electrode current collector plate, the second electrode current collector plate, and the electrolytic solution. The bottom part of the battery can is opposed to the second end face with the second electrode current collector plate interposed between the bottom part and the second end face. The sidewall part of the battery can stands on the bottom part to surround the electrode wound body. The first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate. The second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate. In the electrode wound body, an outermost wind part of the second electrode is located on an outer side relative to an outermost wind part of the first electrode. The sidewall part of the battery can includes a thin part and a thick part. The thick part protrudes toward an inner side of the battery can along a radial direction of the electrode wound body, the radial direction being orthogonal to the first direction. The thick part is located to overlap, in the radial direction, an end part of the first electrode covered part, the end part being located on a side of the first end face in the first direction. The movable part is configured to receive electric power from the secondary battery.

Electronic equipment according to an embodiment of the present disclosure includes a secondary battery as an electric power supply source. The secondary battery includes an electrode wound body, a first electrode current collector plate, a second electrode current collector plate, an electrolytic solution, and a battery can. The electrode wound body includes a stacked structure wound around a central axis extending in a first direction. The stacked structure includes a first electrode and a second electrode that are stacked with a separator interposed between the first electrode and the second electrode. The first electrode current collector plate is disposed to face a first end face of the electrode wound body, the first end face being in the first direction. The second electrode current collector plate is disposed to face a second end face of the electrode wound body. The second end face is opposite to the first end face in the first direction. The battery can includes a bottom part and a sidewall part, and contains the electrode wound body, the first electrode current collector plate, the second electrode current collector plate, and the electrolytic solution. The bottom part of the battery can is opposed to the second end face with the second electrode current collector plate interposed between the bottom part and the second end face. The sidewall part of the battery can stands on the bottom part to surround the electrode wound body. The first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate. The second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate. In the electrode wound body, an outermost wind part of the second electrode is located on an outer side relative to an outermost wind part of the first electrode. The sidewall part of the battery can includes a thin part and a thick part. The thick part protrudes toward an inner side of the battery can along a radial direction of the electrode wound body, the radial direction being orthogonal to the first direction. The thick part is located to overlap, in the radial direction, an end part of the first electrode covered part, the end part being located on a side of the first end face in the first direction.

### BRIEF DESCRIPTION OF THE FIGURES

The accompanying drawings are included to provide a further understanding of the present disclosure, according to an embodiment, and are incorporated in and constitute a part of this specification.

FIG. 1 is a sectional diagram illustrating a configuration of a secondary battery according to an embodiment of the present disclosure.

FIG. 2 is a sectional diagram illustrating an enlarged partial configuration of the secondary battery illustrated in FIG. 1.

FIG. 3 is a schematic diagram illustrating a configuration example of a stacked structure including a positive electrode, a negative electrode, and a separator illustrated in FIG. 1.

FIG. 4 is a sectional diagram illustrating a configuration example of a sectional structure of an electrode wound body illustrated in FIG. 1.

FIG. 5A is a developed view of the positive electrode illustrated in FIG. 1.

FIG. 5B is a sectional view of the positive electrode illustrated in FIG. 1.

FIG. 6A is a developed view of the negative electrode illustrated in FIG. 1.

FIG. 6B is a sectional view of the negative electrode illustrated in FIG. 1.

FIG. 7A is a plan view of a positive electrode current collector plate illustrated in FIG. 1.

FIG. 7B is a plan view of a negative electrode current collector plate illustrated in FIG. 1.

FIGS. 8A to 8F are each a perspective diagram describing a process of manufacturing the secondary battery illustrated in FIG. 1.

FIG. 9 is a block diagram illustrating a circuit configuration of a battery pack to which the secondary battery according to an embodiment of the present disclosure is applied.

FIG. 10 is a schematic diagram illustrating a configuration of an electric tool to which the secondary battery according to an embodiment of the present disclosure is applicable.

FIG. 11 is a schematic diagram illustrating a configuration of an unmanned aircraft to which the secondary battery according to an embodiment of the present disclosure is applicable.

FIG. 12 is a schematic diagram illustrating a configuration of an electric power storage system for an electric vehicle to which the secondary battery according to an embodiment of the present disclosure is applied.

### DETAILED DESCRIPTION

Consideration has been given in various ways to improve performance of a secondary battery. However, there is still room for improvement in performance of the secondary battery.

It is desirable to provide a secondary battery having high safety, and to provide a battery pack, electronic equipment, an electric tool, an electric aircraft, and an electric vehicle that each include such a secondary battery.

In the following, one or more embodiments of the present disclosure are described in further detail including with reference to the accompanying drawings. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

A description is given first of a secondary battery according to an embodiment of the present disclosure.

In an embodiment, a cylindrical lithium-ion secondary battery having an outer appearance of a cylindrical shape will be described as an example. However, the secondary battery of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. For example, an electrochemical capacity per unit area of the negative electrode is set to be greater than an electrochemical capacity per unit area of the positive electrode.

The electrode reactant is not particularly limited in kind, as described above. For example, the electrode reactant may be a light metal such as an alkali metal or an alkaline earth metal. Non-limiting examples of the alkali metal include lithium, sodium, and potassium. Non-limiting examples of the alkaline earth metal include beryllium, magnesium, and calcium.

In the following, described as an example is a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

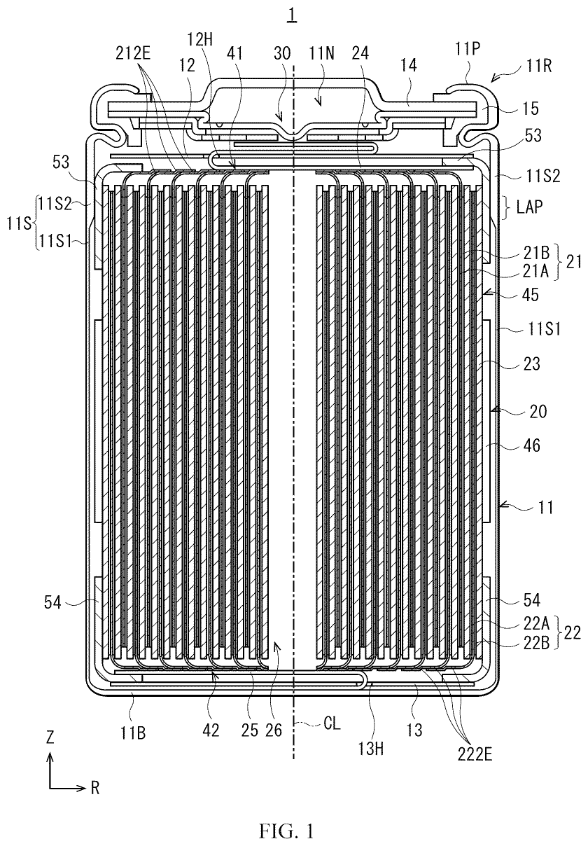

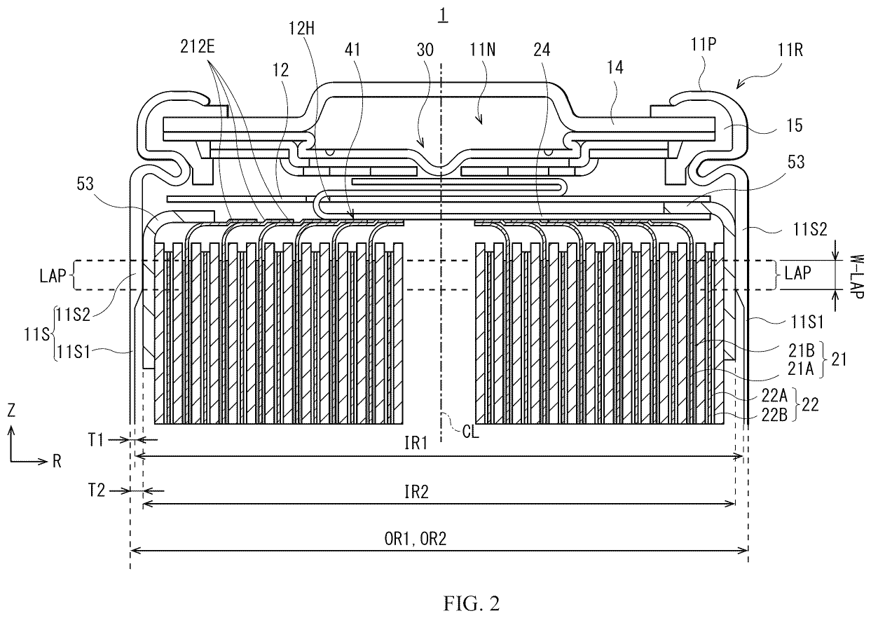

FIG. 1 illustrates a sectional configuration of a lithium-ion secondary battery 1 (hereinafter simply referred to as a secondary battery 1) according to an embodiment along a height direction. In the secondary battery 1 illustrated in FIG. 1, an electrode wound body 20 as a battery device is contained inside an outer package can 11 having a cylindrical shape. FIG. 2 is an enlarged sectional view of an upper part of the secondary battery 1.

For example, the secondary battery 1 includes, inside the outer package can 11, a pair of insulating plates 12 and 13 and the electrode wound body 20, for example. The electrode wound body 20 is a structure in which a positive electrode 21 and a negative electrode 22 are stacked with a separator 23 interposed therebetween and are wound, for example. The electrode wound body 20 has an end face 41 located in an upper part of the electrode wound body 20 and an end face 42 located in a lower part of the electrode wound body 20. The electrode wound body 20 is impregnated with an electrolytic solution. The electrolytic solution is a liquid electrolyte. In an embodiment, the secondary battery 1 may further include a thermosensitive resistive device, a reinforcing member, or both inside the outer package can 11. Non-limiting examples of the thermosensitive resistive device may include a positive temperature coefficient (PTC) device.

The outer package can 11 is a container to contain the electrode wound body 20, a positive electrode current collector plate 24, a negative electrode current collector plate 25, and an electrolytic solution. The outer package can 11 has, for example, a hollow cylindrical structure having an upper end part and a lower end part in a Z-axis direction. The Z-axis direction is the height direction. The lower end part is closed, and the upper end part is open. Specifically, the outer package can 11 includes a bottom part 11B and a sidewall part 11S. The bottom part 11B is opposed to the end face 42 with the negative electrode current collector plate 25 interposed between the bottom part 11B and the end face 42. The negative electrode current collector plate 25 will be described later. The sidewall part 11S stands on the bottom part 11B to surround the electrode wound body 20. The bottom part 11B is a plate-shaped member having a substantially circular plan shape, for example. The sidewall part 11S is a substantially cylindrical member having an outer diameter substantially the same as an outer diameter of the bottom part 11B, for example. The upper end part of the outer package can 11 in the Z-axis direction is an open end part 11N. Note that in the present specification, the open end part 11N and a vicinity thereof in the Z-axis direction may be referred to as the upper part of the secondary battery 1, and a portion where the outer package can 11 is closed and a vicinity thereof in the Z-axis direction may be referred to as a lower part of the secondary battery 1. The sidewall part 11S of the outer package can 11 includes a thin part 11S1 and a thick part 11S2. The thick part 11S2 is provided at an upper end part of the sidewall part 11S in the Z-axis direction of the outer package can 11. As illustrated in FIG. 2, the thick part 11S2 has a thickness T2 in a radial direction (i.e., an R direction) greater than a thickness T1 of the thin part 11S1, that is, T2>T1 is satisfied. In an embodiment, the thickness T2 of the thick part 11S2 may be within a range from 110% to 180%, both inclusive, of the thickness T1 of the thin part 11S1. In a section along the Z-axis direction, the thick part 11S2 protrudes toward an inner side of the outer package can 11 relative to the thin part 11S1. Accordingly, the thick part 11S2 has an inner diameter IR2 smaller than an inner diameter IR1 of the thin part 11S1, that is, IR1>IR2 is satisfied. In an embodiment, the inner diameter IR1 of the thin part 11S1 may be within a range from 100.19% to 100.87%, both inclusive, of the inner diameter IR2 of the thick part 11S2. In an embodiment, as illustrated in FIG. 2, an outer diameter OR1 of the thin part 11S1 and an outer diameter OR2 of the thick part 11S2 may be substantially the same, that is, OR1≈OR2 may be satisfied. In other words, an outer peripheral surface of the thin part 11S1 and an outer peripheral surface of the thick part 11S2 may constitute a common curved surface, e.g., a common cylindrical outer peripheral surface.

The outer package can 11 includes, for example, a metal material such as iron. In an embodiment, a surface of the outer package can 11 may be plated with, for example, a metal material such as nickel. The insulating plate 12 and the insulating plate 13 are opposed to each other to allow the electrode wound body 20 to be interposed therebetween in the Z-axis direction, for example.

Each of the insulating plates 12 and 13 is, for example, a dish-shaped plate having a surface perpendicular to a winding axis of the electrode wound body 20, that is, a surface perpendicular to the Z-axis direction in FIG. 1. The insulating plates 12 and 13 are disposed to allow the electrode wound body 20 to be interposed therebetween.

For example, a structure in which a battery cover 14 and a safety valve mechanism 30 are crimped with a gasket 15 interposed therebetween, that is, a crimped structure 11R, is provided at the open end part 11N of the outer package can 11. The outer package can 11 is sealed by the battery cover 14, with the electrode wound body 20 and other components being contained inside the outer package can 11. The crimped structure 11R includes a bent part 11P serving as what is called a crimped part.

The battery cover 14 is a closing member that closes the open end part 11N of the outer package can 11 in a state where the electrode wound body 20 and other components are contained inside the outer package can 11, for example. The battery cover 14 includes a material similar to the material included in the outer package can 11, for example. A middle region of the battery cover 14 protrudes upward, i.e., in a +Z direction, for example. As a result, a peripheral region, i.e., a region other than the middle region, of the battery cover 14 is in a state of being in contact with the safety valve mechanism 30, for example.

The gasket 15 is a sealing member interposed between the bent part 11P of the outer package can 11 and the battery cover 14, for example. The gasket 15 seals a gap between the bent part 11P and the battery cover 14. In an embodiment, a surface of the gasket 15 may be coated with, for example, asphalt. The gasket 15 includes any one or more of insulating materials, for example. The insulating material is not particularly limited in kind. Non-limiting examples of the insulating material may include a polymer material such as polybutylene terephthalate (PBT) or polypropylene (PP). In an embodiment, the insulating material may be PBT. A reason for this is that this helps to allow for sufficient sealing of the gap between the bent part 11P and the battery cover 14, with the outer package can 11 and the battery cover 14 being electrically separated from each other.

The safety valve mechanism 30 is adapted to cancel the sealed state of the outer package can 11 to thereby release a pressure inside the outer package can 11, i.e., an internal pressure of the outer package can 11 on an as-needed basis, upon an increase in the internal pressure, for example. Non-limiting examples of a cause of the increase in the internal pressure of the outer package can 11 include a gas generated due to a decomposition reaction of the electrolytic solution upon charging and discharging. The internal pressure of the outer package can 11 can also increase due to heating from outside.

The electrode wound body 20 is a power generation device that causes charging and discharging reactions to proceed, and is contained inside the outer package can 11. The electrode wound body 20 includes the positive electrode 21, the negative electrode 22, the separator 23, and the electrolytic solution as a liquid electrolyte.

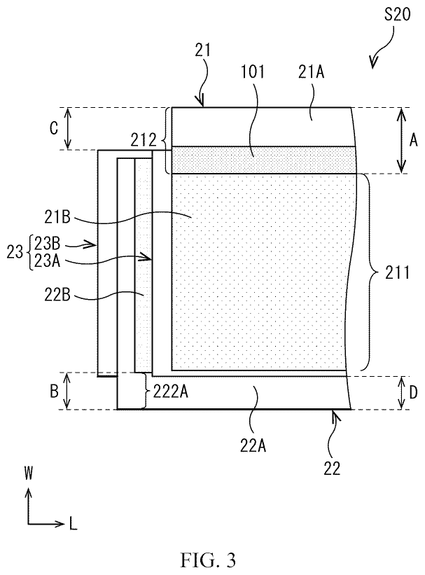

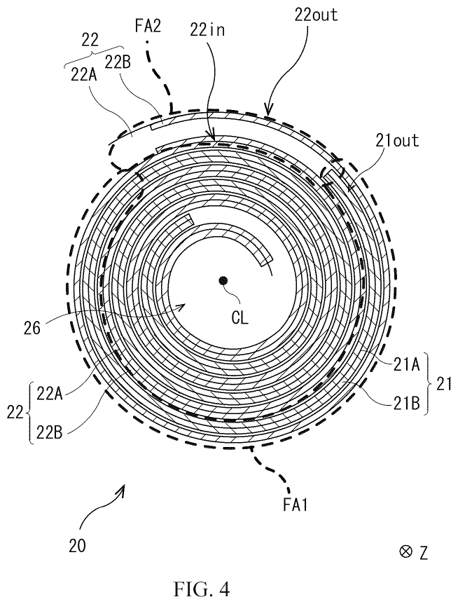

FIG. 3 is a developed view of the electrode wound body 20, and schematically illustrates a portion of a stacked structure S20 including the positive electrode 21, the negative electrode 22, and the separator 23. In the electrode wound body 20, the positive electrode 21 and the negative electrode 22 are stacked on each other with the separator 23 interposed therebetween. The separator 23 includes, for example, two bases, that is, a first separator member 23A and a second separator member 23B. Accordingly, the electrode wound body 20 includes the stacked structure S20 that is four-layered. In the four-layered stacked structure S20, the positive electrode 21, the first separator member 23A, the negative electrode 22, and the second separator member 23B are stacked in order. Each of the positive electrode 21, the first separator member 23A, the negative electrode 22, and the second separator member 23B is a substantially band-shaped member in which a W-axis direction is a transverse direction and an L-axis direction is a longitudinal direction. As illustrated in FIG. 4, the electrode wound body 20 includes the stacked structure S20 that is so wound around a central axis CL (see FIG. 1) extending in the Z-axis direction as to form a spiral shape in a horizontal section orthogonal to the Z-axis direction. Here, the stacked structure S20 is wound in an orientation in which the W-axis direction substantially coincides with the Z-axis direction. Note that FIG. 4 illustrates a configuration example of the electrode wound body 20 along the horizontal section orthogonal to the Z-axis direction. To secure visibility, however, FIG. 4 omits illustration of the separator 23. The electrode wound body 20 has an outer appearance of a substantially circular columnar shape as a whole. The positive electrode 21 and the negative electrode 22 are wound, remaining in a state of being opposed to each other with the separator 23 interposed therebetween. The electrode wound body 20 has a through hole 26 as an internal space at a center of the electrode wound body 20. The through hole 26 is a hole into which a winding core for assembling the electrode wound body 20 and an electrode rod for welding are each to be put.

The positive electrode 21, the negative electrode 22, and the separator 23 are so wound that the separator 23 is located in each of an outermost wind of the electrode wound body 20 and an innermost wind of the electrode wound body 20. Further, in the outermost wind of the electrode wound body 20, the negative electrode 22 is located on an outer side relative to the positive electrode 21. For example, as illustrated in FIG. 4, an outermost positive electrode wind part 21out located in an outermost wind of the positive electrode 21 included in the electrode wound body 20 is located on an inner side relative to an outermost negative electrode wind part 22out located in an outermost wind of the negative electrode 22 included in the electrode wound body 20. Here, the outermost positive electrode wind part 21out is a part corresponding to the outermost one wind of the positive electrode 21 in the electrode wound body 20. The outermost negative electrode wind part 22out is a part corresponding to the outermost one wind of the negative electrode 22 in the electrode wound body 20. As illustrated in FIG. 4, the electrode wound body 20 includes an opposed region FA1 in which the outermost positive electrode wind part 21 out and the outermost negative electrode wind part 22out are opposed to each other, and an opposed region FA2 in which portions of the negative electrode 22 are opposed to each other. The opposed region FA2 is a region in which the outermost negative electrode wind part 22out and an inner negative electrode wind part 22 in are opposed to each other without the positive electrode 21 interposed therebetween. The inner negative electrode wind part 22 in is located on the inner side relative to the outermost negative electrode wind part 22out. In contrast, in the innermost wind of the electrode wound body 20, for example, the negative electrode 22 is located on the inner side relative to the positive electrode 21. For example, an innermost negative electrode wind part located in an innermost wind of the negative electrode 22 included in the electrode wound body 20 is preferably located on the inner side relative to an innermost positive electrode wind part located in an innermost wind of the positive electrode 21 included in the electrode wound body 20. Here, the innermost positive electrode wind part is a part corresponding to the innermost one wind of the positive electrode 21 in the electrode wound body 20. The innermost negative electrode wind part is a part corresponding to the innermost one wind of the negative electrode 22 in the electrode wound body 20. The number of winds of each of the positive electrode 21, the negative electrode 22, and the separator 23 is not particularly limited, and may be chosen as desired.

FIG. 5A is a developed view of the positive electrode 21, and schematically illustrates a state before being wound. FIG. 5B illustrates a sectional configuration of the positive electrode 21. Note that FIG. 5B illustrates a section as viewed in an arrowed direction along line VB-VB illustrated in FIG. 5A. The positive electrode 21 includes, for example, a positive electrode current collector 21A, and a positive electrode active material layer 21B provided on the positive electrode current collector 21A. The positive electrode active material layer 21B may be provided only on one of two opposite surfaces of the positive electrode current collector 21A, or may be provided on each of the two opposite surfaces of the positive electrode current collector 21A, for example. FIG. 5B illustrates a case where the positive electrode active material layer 21B is provided on each of the two opposite surfaces of the positive electrode current collector 21A.

The positive electrode 21 includes a positive electrode covered part 211 in which the positive electrode current collector 21A is covered with the positive electrode active material layer 21B, and a positive electrode exposed part 212 in which the positive electrode current collector 21A is exposed without being covered with the positive electrode active material layer 21B. As illustrated in FIG. 5A, the positive electrode covered part 211 and the positive electrode exposed part 212 each extend from an outer winding side edge 21E1 to an inner winding side edge 21E2 in the electrode wound body 20 along the L-axis direction, i.e., the longitudinal direction. Here, the L-axis direction corresponds to a winding direction of the electrode wound body 20. That is, in the positive electrode 21, the positive electrode current collector 21A is covered with the positive electrode active material layer 21B from the outer winding side edge 21E1 of the positive electrode 21 to the inner winding side edge 21E2 of the positive electrode 21 in the winding direction of the electrode wound body 20. The positive electrode covered part 211 and the positive electrode exposed part 212 are adjacent to each other in the W-axis direction, i.e., the transverse direction. Note that the positive electrode exposed part 212 is coupled to the positive electrode current collector plate 24, as illustrated in FIG. 1. In an embodiment, an insulating layer 101 may be provided in the vicinity of a border between the positive electrode covered part 211 and the positive electrode exposed part 212. In an embodiment, as with the positive electrode covered part 211 and the positive electrode exposed part 212, the insulating layer 101 may also extend from an innermost wind side end part of the electrode wound body 20 to an outermost wind side end part of the electrode wound body 20. In an embodiment, the insulating layer 101 may be adhered to the first separator member 23A, the second separator member 23B, or both. A reason for this is that this helps to prevent the positive electrode 21 and the separator 23 from becoming misaligned with each other. In an embodiment, the insulating layer 101 may include a resin including polyvinylidene difluoride (PVDF). A reason for this is that when the insulating layer 101 includes PVDF, the insulating layer 101 is swollen by, for example, a solvent included in the electrolytic solution, which helps to allow the insulating layer 101 to be favorably adhered to the separator 23. Note that a detailed configuration of the positive electrode 21 will be described later.

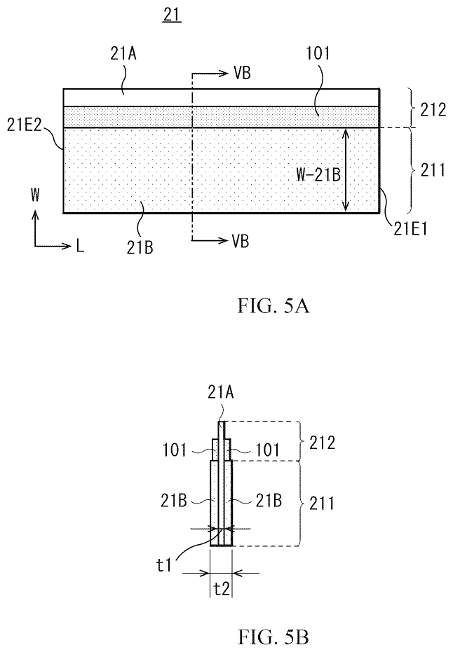

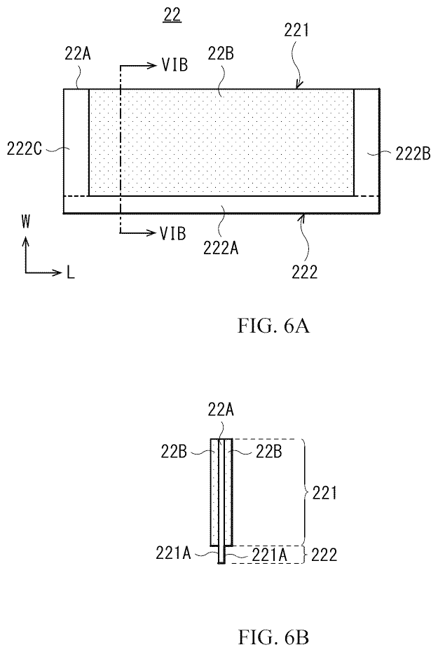

FIG. 6A is a developed view of the negative electrode 22, and schematically illustrates a state before being wound. FIG. 6B illustrates a sectional configuration of the negative electrode 22. Note that FIG. 6B illustrates a section as viewed in an arrowed direction along line VIB-VIB illustrated in FIG. 6A. The negative electrode 22 includes, for example, a negative electrode current collector 22A, and a negative electrode active material layer 22B provided on the negative electrode current collector 22A. The negative electrode active material layer 22B may be provided only on one of two opposite surfaces of the negative electrode current collector 22A, or may be provided on each of the two opposite surfaces of the negative electrode current collector 22A, for example. FIG. 6B illustrates a case where the negative electrode active material layer 22B is provided on each of the two opposite surfaces of the negative electrode current collector 22A.

The negative electrode 22 includes a negative electrode covered part 221 in which the negative electrode current collector 22A is covered with the negative electrode active material layer 22B, and a negative electrode exposed part 222 in which the negative electrode current collector 22A is exposed without being covered with the negative electrode active material layer 22B. As illustrated in FIG. 6A, the negative electrode covered part 221 and the negative electrode exposed part 222 each extend along the L-axis direction, i.e., the longitudinal direction. The negative electrode exposed part 222 extends from the innermost wind side end part of the electrode wound body 20 to the outermost wind side end part of the electrode wound body 20. In contrast, the negative electrode covered part 221 is provided at neither the innermost wind side end part of the electrode wound body 20 nor the outermost wind side end part of the electrode wound body 20. As illustrated in FIG. 6A, regions of the negative electrode exposed part 222 are provided to sandwich the negative electrode covered part 221 in the L-axis direction, i.e., the longitudinal direction. For example, the negative electrode exposed part 222 includes a first region 222A, a second region 222B, and a third region 222C. The first region 222A is provided to be adjacent to the negative electrode covered part 221 in the W-axis direction, and extends in the L-axis direction from the innermost wind side end part of the electrode wound body 20 to the outermost wind side end part of the electrode wound body 20. The second region 222B and the third region 222C are provided to sandwich the negative electrode covered part 221 in the L-axis direction. For example, the second region 222B is located in the vicinity of the innermost wind side end part of the electrode wound body 20, and the third region 222C is located in the vicinity of the outermost wind side end part of the electrode wound body 20. Note that as illustrated in FIG. 1, the first region 222A of the negative electrode exposed part 222 is coupled to the negative electrode current collector plate 25. A detailed configuration of the negative electrode 22 will be described later.

In the secondary battery 1, the stacked structure S20 of the electrode wound body 20 includes the positive electrode 21 and the negative electrode 22 that are so stacked with the separator 23 interposed therebetween that the positive electrode exposed part 212 and the first region 222A of the negative electrode exposed part 222 face toward mutually opposite directions along the W-axis direction, i.e., a width direction. In the electrode wound body 20, a fixing tape 46 is attached to a side surface part 45 of the electrode wound body 20 to fix an end part of the separator 23 and to thereby prevent loosening of winding.

In an embodiment, as illustrated in FIG. 3, the secondary battery 1 may satisfy A>B, where A is a width of the positive electrode exposed part 212, and B is a width of the first region 222A of the negative electrode exposed part 222. For example, when the width A is 7 (mm), the width B is 4 (mm). In an embodiment, the secondary battery 1 may satisfy C>D, where C is a width of a portion of the positive electrode exposed part 212 protruding from an outer edge in the width direction of the separator 23, and D is a width of a portion of the first region 222A of the negative electrode exposed part 222 protruding from an opposite outer edge in the width direction of the separator 23. For example, when the width C is 4.5 (mm), the width D is 3 (mm).

As illustrated in FIG. 1, in the upper part of the secondary battery 1, first edge parts 212E, of the positive electrode exposed part 212 wound around the central axis CL, that are adjacent to each other in the radial direction, i.e., the R direction, of the electrode wound body 20 are so bent toward the central axis CL as to overlap each other. Similarly, in the lower part of the secondary battery 1, second edge parts 222E, of the negative electrode exposed part 222 wound around the central axis CL, that are adjacent to each other in the radial direction, i.e., the R direction, are so bent toward the central axis CL as to overlap each other. Accordingly, the first edge parts 212E of the positive electrode exposed part 212 gather at the end face 41 located in the upper part of the electrode wound body 20, and the second edge parts 222E of the negative electrode exposed part 222 gather at the end face 42 located in the lower part of the electrode wound body 20. To achieve better contact between the positive electrode current collector plate 24 for extracting a current and the first edge parts 212E, the first edge parts 212E bent toward the central axis CL form a flat surface. Similarly, to achieve better contact between the negative electrode current collector plate 25 for extracting a current and the second edge parts 222E, the second edge parts 222E bent toward the central axis CL form a flat surface. Note that as used herein, the term “flat surface” encompasses not only a completely flat surface but also a surface having some asperities or surface roughness to the extent that joining of the positive electrode exposed part 212 to the positive electrode current collector plate 24 and joining of the negative electrode exposed part 222 to the negative electrode current collector plate 25 are possible.

The positive electrode current collector 21A includes an aluminum foil, for example, as will be described later. The negative electrode current collector 22A includes a copper foil, for example, as will be described later. In this case, the positive electrode current collector 21A is softer than the negative electrode current collector 22A. In other words, the positive electrode exposed part 212 has a Young's modulus lower than a Young's modulus of the negative electrode exposed part 222. Accordingly, in an embodiment, the secondary battery 1 may satisfy both A>B and C>D. In such a case, when the positive electrode exposed part 212 and the negative electrode exposed part 222 are simultaneously bent with equal pressures from both electrode sides, the bent portion in the positive electrode 21 and the bent portion in the negative electrode 22 sometimes become equal in height as measured from respective ends of the separator 23. At this time, the first edge parts 212E (FIG. 1) of the positive electrode exposed part 212 appropriately overlap each other by being bent. This allows for easy joining of the positive electrode exposed part 212 and the positive electrode current collector plate 24 to each other. Similarly, the second edge parts 222E (FIG. 1) of the negative electrode exposed part 222 appropriately overlap each other by being bent. This allows for easy joining of the negative electrode exposed part 222 and the negative electrode current collector plate 25 to each other. As used herein, the term “joining” refers to coupling by, for example, laser welding; however, a method of joining is not limited to laser welding. In an embodiment, any other coupling method may be used.

Further, as illustrated in FIGS. 1 and 2, the thick part 11S2 is located to overlap, in the radial direction (the R direction), an end part of the positive electrode active material layer 21B, the end part being located on a side of the end face 41 in the Z-axis direction. In other words, the secondary battery 1 includes an overlap part LAP in which the thick part 11S2 and a portion of the positive electrode active material layer 21B overlap each other. In an embodiment, the overlap part LAP in which the thick part 11S2 and the positive electrode active material layer 21B overlap each other may have a width W-LAP in the Z-axis direction that falls within a range from 0.5 mm to 5.0 mm both inclusive, for example. In an embodiment, a ratio W-LAP/W-21B of the width W-LAP of the overlap part LAP in the Z-axis direction to a width W-21B (FIG. 5A) of the positive electrode active material layer 21B in the Z-axis direction may fall within a range from 0.8% to 8.5% both inclusive, for example.

As illustrated in FIG. 3, a portion, of the positive electrode exposed part 212 of the positive electrode 21, that is opposed to the negative electrode 22 with the separator 23 interposed therebetween is covered with the insulating layer 101. The insulating layer 101 has a width of, for example, 3 mm in the W-axis direction. The insulating layer 101 entirely covers a region of the positive electrode exposed part 212 of the positive electrode 21 that is opposed to the negative electrode covered part 221 of the negative electrode 22 with the separator 23 interposed therebetween. The insulating layer 101 helps to effectively prevent an internal short circuit of the secondary battery 1 when foreign matter enters between the negative electrode covered part 221 and the positive electrode exposed part 212, for example. Further, when the secondary battery 1 undergoes an impact, the insulating layer 101 absorbs the impact, thereby helping to effectively prevent bending of the positive electrode exposed part 212 and a short circuit between the positive electrode exposed part 212 and the negative electrode 22.

The secondary battery 1 may further include insulating tapes 53 and 54 in a gap between the outer package can 11 and the electrode wound body 20. The positive electrode exposed part 212 having portions gathering at the end face 41 and the negative electrode exposed part 222 having portions gathering at the end face 42 are conductors, such as metal foils, that are exposed. Accordingly, if the positive electrode exposed part 212 and the negative electrode exposed part 222 are in close proximity to the outer package can 11, a short circuit between the positive electrode 21 and the negative electrode 22 can occur via the outer package can 11. A short circuit can also occur when the positive electrode current collector plate 24 on the end face 41 and the outer package can 11 come into close proximity to each other. To address this, in an embodiment, the insulating tapes 53 and 54 may be provided as insulating members. Each of the insulating tapes 53 and 54 is an adhesive tape including a base layer, and an adhesive layer provided on one surface of the base layer. The base layer includes, for example, any one of polypropylene, polyethylene terephthalate, or polyimide. To prevent the provision of the insulating tapes 53 and 54 from resulting in a decreased capacity of the electrode wound body 20, the insulating tapes 53 and 54 are disposed not to overlap the fixing tape 46 attached to the side surface part 45, and a thickness of each of the insulating tapes 53 and 54 is set to be less than or equal to a thickness of the fixing tape 46.

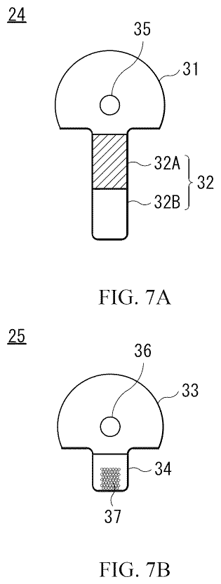

In a typical lithium-ion secondary battery, for example, a lead for current extraction is welded to one location on each of the positive electrode and the negative electrode. However, this increases an internal resistance of the lithium-ion secondary battery and causes the lithium-ion secondary battery to generate heat to become hot upon discharging; therefore, such a configuration is unsuitable for high-rate discharging. To address this, in the secondary battery 1 according to the example embodiment, the positive electrode current collector plate 24 is disposed to face the end face 41, and the negative electrode current collector plate 25 is disposed to face the end face 42. In addition, the positive electrode exposed part 212 located at the end face 41 and the positive electrode current collector plate 24 are welded to each other at multiple points; and the negative electrode exposed part 222 located at the end face 42 and the negative electrode current collector plate 25 are welded to each other at multiple points. A reduced internal resistance of the secondary battery 1 is thereby achieved. Each of the end faces 41 and 42 being a flat surface as described above also contributes to the reduced resistance. The positive electrode current collector plate 24 is electrically coupled to the battery cover 14 via the safety valve mechanism 30, for example. The negative electrode current collector plate 25 is electrically coupled to the outer package can 11, for example. FIG. 7A is a schematic diagram illustrating a configuration example of the positive electrode current collector plate 24. FIG. 7B is a schematic diagram illustrating a configuration example of the negative electrode current collector plate 25. The positive electrode current collector plate 24 is a metal plate including, for example, aluminum or an aluminum alloy as a single component, or a composite material of aluminum and the aluminum alloy. The negative electrode current collector plate 25 is a metal plate including, for example, nickel, a nickel alloy, copper, or a copper alloy as a single component, or a composite material of two or more thereof.

As illustrated in FIG. 7A, the positive electrode current collector plate 24 has a shape in which a band-shaped part 32 having a substantially rectangular shape is coupled to a fan-shaped part 31 having a substantially fan shape. The fan-shaped part 31 has a through hole 35 in the vicinity of a middle thereof. In the secondary battery 1, the positive electrode current collector plate 24 is provided to allow the through hole 35 to overlap the through hole 26 in the Z-axis direction. A hatched portion in FIG. 7A represents an insulating part 32A of the band-shaped part 32. The insulating part 32A is a portion of the band-shaped part 32 and has an insulating tape attached thereto or an insulating material applied thereto. Of the band-shaped part 32, a portion below the insulating part 32A is a coupling section 32B to be coupled to a sealing plate that also serves as an external terminal. Note that when the secondary battery 1 has a battery structure without a metallic center pin in the through hole 26 as illustrated in FIG. 1, there is a low possibility that the band-shaped part 32 will come into contact with a region of a negative electrode potential. In such a case, the positive electrode current collector plate 24 does not have to include the insulating part 32A. When the positive electrode current collector plate 24 does not include the insulating part 32A, it is possible to increase a width of each of the positive electrode 21 and the negative electrode 22 by an amount corresponding to a thickness of the insulating part 32A to thereby increase a charge and discharge capacity.

The negative electrode current collector plate 25 illustrated in FIG. 7B has a shape similar to the shape of the positive electrode current collector plate 24 illustrated in FIG. 7A. That is, the negative electrode current collector plate 25 has a shape in which a band-shaped part 34 having a substantially rectangular shape is coupled to a fan-shaped part 33 having a substantially fan shape. The fan-shaped part 33 of the negative electrode current collector plate 25 has an outer shape defined by an outline part having a substantially arc shape and an outline part extending substantially linearly. The band-shaped part 34 of the negative electrode current collector plate 25 is different from the band-shaped part 32 of the positive electrode current collector plate 24. The band-shaped part 34 of the negative electrode current collector plate 25 is shorter than the band-shaped part 32 of the positive electrode current collector plate 24, and includes no portion corresponding to the insulating part 32A of the positive electrode current collector plate 24. The band-shaped part 34 is provided with projections 37 that each have a round shape and that are depicted as multiple circles. Upon resistance welding, a current is concentrated on the projections 37, causing the projections 37 to melt to cause the band-shaped part 34 to be welded to a bottom of the outer package can 11. As with the positive electrode current collector plate 24, the negative electrode current collector plate 25 has a through hole 36 in the vicinity of a middle of the fan-shaped part 33. In the secondary battery 1, the negative electrode current collector plate 25 is provided to allow the through hole 36 to overlap the through hole 26 in the Z-axis direction.

The fan-shaped part 31 of the positive electrode current collector plate 24 covers only a portion of the end face 41, owing to a plan shape of the fan-shaped part 31. Similarly, the fan-shaped part 33 of the negative electrode current collector plate 25 covers only a portion of the end face 42, owing to a plan shape of the fan-shaped part 33. Reasons why the fan-shaped parts 31 and 33 are not allowed to respectively cover the entire end faces 41 and 42 include the following reasons, for example. One reason is to allow the electrolytic solution to smoothly permeate the electrode wound body 20 in assembling the secondary battery 1, for example. Another reason is to allow a gas generated when the lithium-ion secondary battery comes into an abnormally hot state or an overcharged state to be easily released to the outside.

The positive electrode current collector 21A includes, for example, an electrically conductive material such as aluminum. The positive electrode current collector 21A is a metal foil including a material such as aluminum or an aluminum alloy.

The positive electrode active material layer 21B includes, as a positive electrode active material, any one or more of positive electrode materials into which lithium is insertable and from which lithium is extractable. In an embodiment, the positive electrode active material layer 21B may further include any one or more of other materials. Non-limiting examples of the other materials include a positive electrode binder and a positive electrode conductor. In an embodiment, the positive electrode material may be a lithium-containing compound. Non-limiting examples of the lithium-containing compound include a lithium-containing composite oxide and a lithium-containing phosphoric acid compound. The lithium-containing composite oxide is an oxide including lithium and one or more of other elements, that is, one or more of elements other than lithium, as constituent elements. The lithium-containing composite oxide has any of crystal structures including, without limitation, a layered rock-salt crystal structure and a spinel crystal structure, for example. The lithium-containing phosphoric acid compound is a phosphoric acid compound including lithium and one or more of other elements as constituent elements, and has a crystal structure such as an olivine crystal structure, for example. In an embodiment, the positive electrode active material layer 21B may include at least one of lithium cobalt oxide, lithium nickel cobalt manganese oxide, or lithium nickel cobalt aluminum oxide, as the positive electrode active material. The positive electrode binder includes, for example, any one or more of materials including, without limitation, a synthetic rubber and a polymer compound. Non-limiting examples of the synthetic rubber include a styrene-butadiene-based rubber, a fluorine-based rubber, and ethylene propylene diene. Non-limiting examples of the polymer compound include polyvinylidene difluoride and polyimide. The positive electrode conductor includes, for example, any one or more of materials including, without limitation, a carbon material. Non-limiting examples of the carbon material include graphite, carbon black, acetylene black, and Ketjen black. Note that the positive electrode conductor may be any of electrically conductive materials, and may be, for example, a metal material or an electrically conductive polymer.

Further, in an embodiment, the positive electrode active material layer 21B may include a fluorine compound and a nitrogen compound. For example, a positive electrode film including the fluorine compound and the nitrogen compound may be provided on a surface of the positive electrode active material layer 21B. In an embodiment, a weight ratio F/N of a fluorine content to a nitrogen content in the positive electrode film of the positive electrode active material layer 21B may be within a range from 3 to 50 both inclusive. For example, the weight ratio F/N of the fluorine content to the nitrogen content in the positive electrode film of the positive electrode active material layer 21B may be within a range from 15 to 35 both inclusive. Note that the weight ratio F/N of the fluorine content to the nitrogen content in the positive electrode film of the positive electrode active material layer 21B is calculable based on, for example, a spectral peak area of a 1s orbital of a nitrogen atom and a spectral peak area of a 1s orbital of a fluorine atom that are measurable by X-ray photoelectron spectroscopy.

In an embodiment, the positive electrode active material layer 21B may have an area density within a range from 21.5 mg/cm² to 23.5 mg/cm² both inclusive. A reason for this is that this helps to allow for suppression of an increase in temperature of the secondary battery 1 at the time of high load rate charging. In an embodiment, as illustrated in FIG. 5B, a ratio t2/t1 of a thickness t2 of the positive electrode covered part 211, that is, a total thickness t2 of the positive electrode current collector 21A and the positive electrode active material layer 21B, to a thickness t1 of the positive electrode current collector 21A may be within a range from 5.0 to 6.5 both inclusive. Here, the thickness t2 of the positive electrode covered part 211 of the positive electrode 21 may be within a range from 60 μm to 90 μm both inclusive, for example. The thickness t1 of the positive electrode current collector 21A may be within a range from 6 μm to 15 μm both inclusive, for example.

The negative electrode current collector 22A includes, for example, an electrically conductive material such as copper. The negative electrode current collector 22A is a metal foil including a material such as nickel, a nickel alloy, copper, or a copper alloy. In an embodiment, a surface of the negative electrode current collector 22A may be roughened. A reason for this is to improve adherence of the negative electrode active material layer 22B to the negative electrode current collector 22A owing to what is called an anchor effect. In this case, the surface of the negative electrode current collector 22A is to be roughened at least in a region facing the negative electrode active material layer 22B. Non-limiting examples of a roughening method include a method in which microparticles are formed through an electrolytic treatment. In the electrolytic treatment, the microparticles are formed on the surface of the negative electrode current collector 22A by an electrolytic method in an electrolyzer. This provides the surface of the negative electrode current collector 22A with asperities. A copper foil produced by the electrolytic method is generally called an electrolytic copper foil.

The negative electrode active material layer 22B includes, as a negative electrode active material, any one or more of negative electrode materials into which lithium is insertable and from which lithium is extractable. In an embodiment, the negative electrode active material layer 22B may further include any one or more of other materials. Non-limiting examples of the other materials include a negative electrode binder and a negative electrode conductor. The negative electrode material is a carbon material, for example. A reason for this is that the carbon material exhibits very little change in crystal structure at the time of insertion and extraction of lithium, and a high energy density is thus obtainable stably. Another reason is that the carbon material also serves as a negative electrode conductor, which helps to allow the negative electrode active material layer 22B to be improved in electrical conductive property. The carbon material may be, for example, graphitizable carbon, non-graphitizable carbon, or graphite. In an embodiment, spacing of a (002) plane of the non-graphitizable carbon may be 0.37 nm or greater. In an embodiment, spacing of a (002) plane of the graphite may be 0.34 nm or less. Non-limiting examples of the carbon material include pyrolytic carbons, cokes, glassy carbon fibers, an organic polymer compound fired body, activated carbon, and carbon blacks. Non-limiting examples of the cokes include pitch coke, needle coke, and petroleum coke. The organic polymer compound fired body is a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon, for example. Note that the carbon material may have any of a fibrous shape, a spherical shape, a granular shape, and a flaky shape. In the secondary battery 1, when an open-circuit voltage in a fully charged state, that is, a battery voltage, is 4.25 V or higher, the amount of extracted lithium per unit mass increases as compared with when the open-circuit voltage in the fully charged state is 4.20 V, even with the same positive electrode active material. The amount of the positive electrode active material and the amount of the negative electrode active material are therefore adjusted accordingly. This helps to obtain a high energy density.

The negative electrode active material layer 22B may include, as the negative electrode active material, a silicon-containing material including at least one of silicon, silicon oxide, a carbon-silicon compound, or a silicon alloy. The term “silicon-containing material” is a generic term for a material that includes silicon as a constituent element. In an embodiment, the silicon-containing material may include only silicon as the constituent element. Only one kind of silicon-containing material may be used, or two or more kinds of silicon-containing materials may be used. The silicon-containing material is able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline part and an amorphous part. Note that the simple substance described here refers to a simple substance merely in a general sense. The simple substance may thus include a small amount of impurity. In other words, purity of the simple substance is not limited to 100%. The silicon alloy includes, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound includes, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Non-limiting examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and SiOᵥ (where 0<v≤2). Note that the range of v may be chosen as desired, and may be, for example, 0.2<v≤1.4.

In an embodiment, the negative electrode active material layer 22B may include graphite and SiO as the negative electrode active material. In such a case, a ratio of a weight of SiO to a total weight of graphite and SiO in the negative electrode active material may be within a range from 3 wt % to 15 wt % both inclusive. A reason for this is that setting the weight ratio of SiO to 3 wt % or greater helps to obtain a sufficient capacity. Further, setting the weight ratio of SiO to 15 wt % or less helps to suppress swelling of the negative electrode, and to allow the electrolytic solution to be sufficiently distributed into the negative electrode active material, thereby helping to ensure favorable ion conductivity. This helps to achieve an improved cyclability characteristic.

The separator 23 is interposed between the positive electrode 21 and the negative electrode 22. The separator 23 allows lithium ions to pass through and prevents a short circuit of a current caused by contact between the positive electrode 21 and the negative electrode 22. The separator 23 includes, for example, any one or more kinds of porous films each including, for example, a synthetic resin or a ceramic, and may include a stacked film of two or more kinds of porous films. Non-limiting examples of the synthetic resin include polytetrafluoroethylene, polypropylene, and polyethylene. In an embodiment, the separator 23 may include the bases that each include a single-layer polyolefin porous film including polyethylene. A reason for this is that a favorable high output characteristic is obtainable as compared with a stacked film. In an embodiment where the first separator member 23A and the second separator member 23B included in the separator 23 each include a single-layer porous film including polyolefin, the porous film may have a thickness within a range from 10 μm to 15 μm both inclusive, for example. An internal short circuit is sufficiently avoidable if the single-layer porous film including polyolefin has a thickness of 10 μm or greater. A more favorable discharge capacity characteristic is achievable if the thickness of the single-layer porous film including polyolefin is 15 μm or less. In an embodiment, the porous film may have a surface density within a range from 6.3 g/m² to 8.3 g/m² both inclusive, for example. An internal short circuit is sufficiently avoidable if the single-layer porous film including polyolefin has a surface density of 6.3 g/m² or greater. A more favorable discharge capacity characteristic is achievable if the surface density of the single-layer porous film including polyolefin is 8.3 g/m² or less.

For example, the separator 23 may include, for example, a porous film as each of the above-described bases, and a polymer compound layer provided on one of or each of two opposite surfaces of each of the bases. A reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the bases are impregnated is also suppressed. This prevents an easy increase in resistance even upon repeated charging and discharging, and also suppresses swelling of the secondary battery. The polymer compound layer includes a polymer compound such as polyvinylidene difluoride. A reason for this is that the polymer compound such as polyvinylidene difluoride has superior physical strength and is electrochemically stable. Note that the polymer compound may be other than polyvinylidene difluoride. To form the polymer compound layer, for example, a solution in which the polymer compound is dissolved in a solvent such as an organic solvent is applied on the base, following which the bases are dried. In an embodiment, the bases may be immersed in the solution and thereafter dried. The polymer compound layer may include any one or more kinds of insulating particles such as inorganic particles, for example. Non-limiting examples of the kind of the inorganic particles include aluminum oxide and aluminum nitride.

The electrolytic solution includes a solvent and an electrolyte salt. In an embodiment, the electrolytic solution may further include any one or more of other materials. Non-limiting examples of the other materials include an additive. The solvent includes any one or more of nonaqueous solvents including, without limitation, an organic solvent. An electrolytic solution including a nonaqueous solvent is what is called a nonaqueous electrolytic solution. The nonaqueous solvent includes a fluorine compound and a dinitrile compound, for example. The fluorine compound includes, for example, at least one of fluorinated ethylene carbonate, trifluorocarbonate, trifluoroethyl methyl carbonate, a fluorinated carboxylic acid ester, or a fluorine ether. The nonaqueous solvent may further include one or more of nitrile compounds other than the dinitrile compound. Non-limiting examples of the nitrile compounds other than the dinitrile compound include a mononitrile compound and a trinitrile compound. In an embodiment, the dinitrile compound may be succinonitrile (SN). However, the dinitrile compound is not limited to succinonitrile, and may be another dinitrile compound such as adiponitrile.

The electrolyte salt includes, for example, any one or more of salts including, without limitation, a lithium salt. Note that the electrolyte salt may include a salt other than the lithium salt, for example. Non-limiting examples of the salt other than the lithium salt include a salt of a light metal other than lithium. Non-limiting examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). For example, the lithium salt is any one or more of LiPF₆, LiBF₄, LiClO₄, or LiAsF₆. In an embodiment, the lithium salt may be LiPF₆. Although not particularly limited, a content of the electrolyte salt is within a range from 0.3 mol/kg to 3 mol/kg both inclusive with respect to the solvent. In an embodiment where the electrolytic solution includes LiPF₆ as the electrolyte salt, a concentration of LiPF₆ in the electrolytic solution may be within a range from 1.25 mol/kg to 1.45 mol/kg both inclusive. A reason for this is that this helps to prevent cycle deterioration caused by consumption, or decomposition, of the salt at the time of high load rate charging, and thus helps to improve a high-load cyclability characteristic. In an embodiment where the electrolytic solution further includes LiBF₄ in addition to LiPF₆ as the electrolyte salt, a concentration of LiBF₄ in the electrolytic solution may be within a range from 0.001 (wt %) to 0.1 (wt %) both inclusive. A reason for this is that this helps to more effectively prevent the cycle deterioration caused by consumption, or decomposition, of the salt at the time of high load rate charging, and thus helps to further improve the high-load cyclability characteristic.

In the secondary battery 1 according to the example embodiment, for example, upon charging, lithium ions are extracted from the positive electrode 21, and the extracted lithium ions are inserted into the negative electrode 22 via the electrolytic solution. In the secondary battery 1, for example, upon discharging, lithium ions are extracted from the negative electrode 22, and the extracted lithium ions are inserted into the positive electrode 21 via the electrolytic solution.

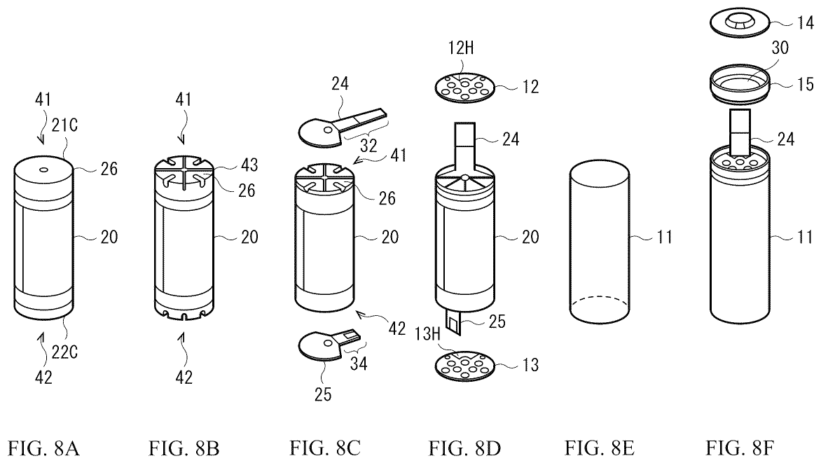

A method of manufacturing the secondary battery 1 will be described with reference to FIGS. 8A to 8F as well as FIGS. 1 to 7B. FIGS. 8A to 8F are each a perspective diagram describing a manufacturing process of the secondary battery 1 illustrated in FIG. 1.

First, the positive electrode current collector 21A is prepared, and the positive electrode active material layer 21B is selectively formed on the surface of the positive electrode current collector 21A to thereby form the positive electrode 21 including the positive electrode covered part 211 and the positive electrode exposed part 212. Thereafter, the negative electrode current collector 22A is prepared, and the negative electrode active material layer 22B is selectively formed on the surface of the negative electrode current collector 22A to thereby form the negative electrode 22 including the negative electrode covered part 221 and the negative electrode exposed part 222. The positive electrode 21 and the negative electrode 22 may be subjected to a drying process. Thereafter, the positive electrode 21 and the negative electrode 22 are stacked, with the first separator member 23A and the second separator member 23B on the positive electrode 21 and the negative electrode 22, respectively, to cause the positive electrode exposed part 212 and the first region 222A of the negative electrode exposed part 222 to be on opposite sides to each other in the W-axis direction. The stacked structure S20 is thereby fabricated. In fabricating the stacked structure S20, an inner winding side end part of the first separator member 23A and an inner winding side end part of the second separator member 23B are folded back, and these inner winding side end parts are caused to be interposed between the inner winding side edge 21E2 of the positive electrode 21 and the negative electrode 22. Thereafter, the stacked structure S20 is so wound in a spiral shape as to form the through hole 26. In addition, the fixing tape 46 is attached to an outermost wind of the stacked structure S20 wound in the spiral shape. The electrode wound body 20 is thus obtained as illustrated in FIG. 8A.

Thereafter, as illustrated in FIG. 8B, the end faces 41 and 42 of the electrode wound body 20 are locally bent by pressing an end of, for example, a 0.5-mm-thick flat plate against each of the end faces 41 and 42 perpendicularly, that is, in the Z-axis direction. As a result, grooves 43 are formed to extend radiately in radial directions (R directions) from the through hole 26. Note that the number and arrangement of the grooves 43 illustrated in FIG. 8B are merely one example, and the present disclosure is not limited thereto.

Thereafter, as illustrated in FIG. 8C, substantially equal pressures are applied to the end faces 41 and 42 in substantially perpendicular directions from above and below the electrode wound body 20 at substantially the same time. At this time, for example, a rod-shaped jig is placed in the through hole 26 in advance. By this operation, the positive electrode exposed part 212 and the first region 222A of the negative electrode exposed part 222 are each bent to make the respective end faces 41 and 42 into flat surfaces. At this time, the first edge parts 212E of the positive electrode exposed part 212 located at the end face 41 are caused to bend toward the through hole 26 while overlapping each other, and the second edge parts 222E of the negative electrode exposed part 222 located at the end face 42 are caused to bend toward the through hole 26 while overlapping each other. Thereafter, the fan-shaped part 31 of the positive electrode current collector plate 24 is joined to the end face 41 by, for example, laser welding, and the fan-shaped part 33 of the negative electrode current collector plate 25 is joined to the end face 42 by, for example, laser welding.

Thereafter, the insulating tapes 53 and 54 are attached to predetermined locations on the electrode wound body 20. Thereafter, as illustrated in FIG. 8D, the band-shaped part 32 of the positive electrode current collector plate 24 is bent and inserted through a hole 12H of the insulating plate 12. Further, the band-shaped part 34 of the negative electrode current collector plate 25 is bent and inserted through a hole 13H of the insulating plate 13.

Thereafter, the electrode wound body 20 having been assembled in the above-described manner is placed into the outer package can 11 illustrated in FIG. 8E, following which the bottom part of the outer package can 11 and the negative electrode current collector plate 25 are welded to each other. Thereafter, a narrow part is formed in the vicinity of the open end part 11N of the outer package can 11. Further, the electrolytic solution is injected into the outer package can 11, following which the band-shaped part 32 of the positive electrode current collector plate 24 and the safety valve mechanism 30 are welded to each other.

Thereafter, as illustrated in FIG. 8F, sealing is performed with the gasket 15, the safety valve mechanism 30, and the battery cover 14.

The secondary battery 1 according to an embodiment is completed in the above-described manner.

As described above, in the secondary battery 1 according to an embodiment, the overlap part LAP is provided in which the thick part 11S2 of the outer package can 11 and the end part, of the positive electrode active material layer 21B, located on the side of the end face 41 overlap each other in the R direction. Accordingly, a region in the vicinity of the end face 41 of the electrode wound body 20 is biased along the R direction toward the central axis CL by the thick part 11S2 protruding toward the inner side of the outer package can 11. This helps to suppress an increase in distance between an end part, of the outermost positive electrode wind part 21out, located on the side of the end face 41 and an end part, of the outermost negative electrode wind part 22out, located on the side of the end face 41. In other words, the positive electrode 21 and the negative electrode 22 are allowed to be kept at an appropriate distance from each other in the overlap part LAP. Accordingly, in the secondary battery 1, precipitation of the electrode reactant, i.e., lithium, on the surface of the negative electrode 22 is suppressed upon charging, which helps to achieve high safety.

In the secondary battery 1, what is called a tabless structure is employed. Accordingly, at the end face 41, the first edge parts 212E of the positive electrode current collector 21A are so bent toward the central axis CL as to overlap each other, as illustrated in, for example, FIG. 1. As a result, it is easier to keep an appropriate distance between the positive electrode 21 and the negative electrode 22 in regions in which the positive electrode 21 and the negative electrode 22 are opposed to each other, except the opposed region FA1 (FIG. 4) in which the outermost positive electrode wind part 21out and the outermost negative electrode wind part 22out are opposed to each other. In contrast, the outermost negative electrode wind part 22out tends to become apart from the outermost positive electrode wind part 21out because no positive electrode 21 is present on the outer winding side relative to the outermost negative electrode wind part 22out. If the distance between the positive electrode 21 and the negative electrode 22 increases, charging can be hindered and lithium metal can precipitate on the negative electrode 22. To address this, in the secondary battery 1, a biasing force directed along the R direction toward the central axis CL is applied to the outermost negative electrode wind part 22out by the thick part 11S2. This helps to keep an appropriate distance between the outermost positive electrode wind part 21out and the outermost negative electrode wind part 22out also in the opposed region FA1 in which the outermost positive electrode wind part 21out and the outermost negative electrode wind part 22out are opposed to each other. As a result, in the secondary battery 1, precipitation of the electrode reactant, i.e., lithium, on the surface of the negative electrode 22 is suppressed upon charging, which helps to achieve high safety.

In an embodiment, the thickness T2 of the thick part 11S2 may be set to 110% or greater of the thickness T1 of the thin part 11S1. This helps to suppress an increase in distance between the positive electrode 21 and the negative electrode 22. As a result, precipitation of the electrode reactant, i.e., lithium, on the surface of the negative electrode 22 is further suppressed, which helps to achieve higher safety. In an embodiment, the thickness T2 of the thick part 11S2 may be set to 180% or less of the thickness T1 of the thin part 11S1. This helps to effectively suppress swelling of the negative electrode 22. Accordingly, the electrolytic solution is sufficiently distributable into the negative electrode active material, and more favorable ion conductivity is thus achievable. This helps to allow for further improvement in cyclability characteristic.

Non-limiting examples of applications of the lithium-ion secondary battery 1 according to an embodiment of the present disclosure are as described below in further detail.

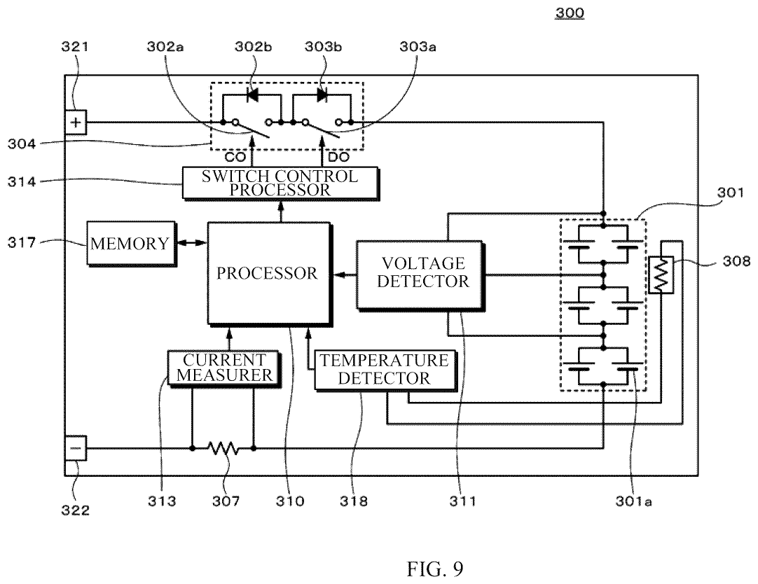

FIG. 9 is a block diagram illustrating a circuit configuration example in which a battery according to an embodiment of the present disclosure is applied to a battery pack 300. Hereinafter, the battery according to an embodiment will be referred to as a “secondary battery” as appropriate. The battery pack 300 includes an assembled battery 301, an outer package, a switcher 304, a current detection resistor 307, a temperature detection device 308, and a processor 310. The switcher 304 includes a charge control switch 302a and a discharge control switch 303a.

The battery pack 300 includes a positive electrode terminal 321 and a negative electrode terminal 322. Upon charging, the positive electrode terminal 321 and the negative electrode terminal 322 are respectively coupled to a positive electrode terminal and a negative electrode terminal of a charger to perform charging. Upon use of electronic equipment, the positive electrode terminal 321 and the negative electrode terminal 322 are respectively coupled to a positive electrode terminal and a negative electrode terminal of the electronic equipment to perform discharging.

The assembled battery 301 includes multiple secondary batteries 301a coupled in series or in parallel. The secondary battery 1 described above is applicable to each of the secondary batteries 301a. Note that FIG. 9 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where each of n and m is an integer.

The switcher 304 includes the charge control switch 302a, a diode 302b, the discharge control switch 303a, and a diode 303b, and is controlled by the processor 310. The diode 302b has a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b has a polarity that is in the forward direction with respect to the charge current and in the reverse direction with respect to the discharge current. Note that although the switcher 304 is provided on a positive side in FIG. 9, the switcher 304 may be provided on a negative side.

The charge control switch 302a is so controlled by a charge and discharge control processor that when the battery voltage reaches an overcharge detection voltage, the charge control switch 302a is turned off to thereby prevent the charge current from flowing through a current path of the assembled battery 301. After the charge control switch 302a is turned off, only discharging is enabled through the diode 302b. Further, the charge control switch 302a is so controlled by the processor 310 that when a large current flows upon charging, the charge control switch 302a is turned off to thereby block the charge current flowing through the current path of the assembled battery 301. The discharge control switch 303a is so controlled by the processor 310 that when the battery voltage reaches an overdischarge detection voltage, the discharge control switch 303a is turned off to thereby prevent the discharge current from flowing through the current path of the assembled battery 301. After the discharge control switch 303a is turned off, only charging is enabled through the diode 303b. Further, the discharge control switch 303a is so controlled by the processor 310 that when a large current flows upon discharging, the discharge control switch 303a is turned off to thereby block the discharge current flowing through the current path of the assembled battery 301.

The temperature detection device 308 is, for example, a thermistor. The temperature detection device 308 is provided in the vicinity of the assembled battery 301, measures a temperature of the assembled battery 301, and supplies the measured temperature to the processor 310. A voltage detector 311 measures a voltage of the assembled battery 301 and a voltage of each of the secondary batteries 301a included in the assembled battery 301, performs A/D conversion on the measured voltages, and supplies the converted voltages to the processor 310. A current measurer 313 measures a current by means of the current detection resistor 307, and supplies the measured current to the processor 310. A switch control processor 314 controls the charge control switch 302a and the discharge control switch 303a of the switcher 304, based on the voltages supplied from the voltage detector 311 and the current supplied from the current measurer 313.

When a voltage of any of the secondary batteries 301a reaches the overcharge detection voltage or below, or reaches the overdischarge detection voltage or below, or when a large current flows suddenly, the switch control processor 314 transmits a control signal to the switcher 304 to thereby prevent overcharging and overdischarging, and overcurrent charging and discharging. For example, when the secondary battery is a lithium-ion secondary battery, the overcharge detection voltage is determined to be, for example, 4.20 V±0.05 V, and the overdischarge detection voltage is determined to be, for example, 2.4 V±0.1 V.

As the charge and discharge control switches, for example, semiconductor switches such as metal-oxide-semiconductor field-effect transistors (MOSFETs) are usable. In this case, parasitic diodes of the MOSFETs serve as the diodes 302b and 303b. When P-channel FETs are used as the charge and discharge control switches, the switch control processor 314 supplies control signals DO and CO to respective gates of the charge control switch 302a and the discharge control switch 303a. When the charge control switch 302a and the discharge control switch 303a are of P-channel type, the charge control switch 302a and the discharge control switch 303a are turned on by a gate potential that is lower than a source potential by a predetermined value or more. For example, in normal charging and discharging operations, the control signals CO and DO are set to a low level to turn on the charge control switch 302a and the discharge control switch 303a.

For example, upon overcharging or overdischarging, the control signals CO and DO are set to a high level to turn off the charge control switch 302a and the discharge control switch 303a.

A memory 317 includes a random access memory (RAM) and a read only memory (ROM). For example, the memory 317 includes an erasable programmable read only memory (EPROM) as a nonvolatile memory. In the memory 317, values including, without limitation, numerical values calculated by the processor 310 and a battery's internal resistance value of each of the secondary batteries 301a in an initial state measured in the manufacturing process stage, are stored in advance and are rewritable on an as-needed basis. Further, storing a full charge capacity of the secondary battery 301a in the memory 317 allows the processor 310 to calculate, for example, a remaining capacity.

A temperature detector 318 measures a temperature with use of the temperature detection device 308, performs charge and discharge control upon abnormal heat generation, and performs correction in calculating the remaining capacity.

The secondary battery according to an embodiment of the present disclosure is mountable on, or usable to supply electric power to, for example, any of equipment including, without limitation, electronic equipment, an electric vehicle, an electric aircraft, and a power storage apparatus.

Non-limiting examples of the electronic equipment include laptop personal computers, smartphones, tablet terminals, personal digital assistants (PDAs) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, traffic lights, and any other electronic equipment to which an embodiment of the present disclosure is applicable.

Non-limiting examples of the electric vehicle include railway vehicles, golf carts, electric carts, electric automobiles including hybrid electric automobiles, and any electric vehicle to which an embodiment of the present disclosure is applicable. The secondary battery is usable as a driving power source or an auxiliary power source for any of these electric vehicles. Non-limiting examples of the electric power storage apparatuses include an electric power storage power source for architectural structures including residential houses, an electric power storage power source for power generation facilities, and any other electric power storage apparatuses to which an embodiment of the present disclosure is applicable.

A description is given below of examples of a power storage system that includes, among the above-described examples of application, the power storage apparatus to which the secondary battery 1 of an embodiment of the present disclosure described above is applied.

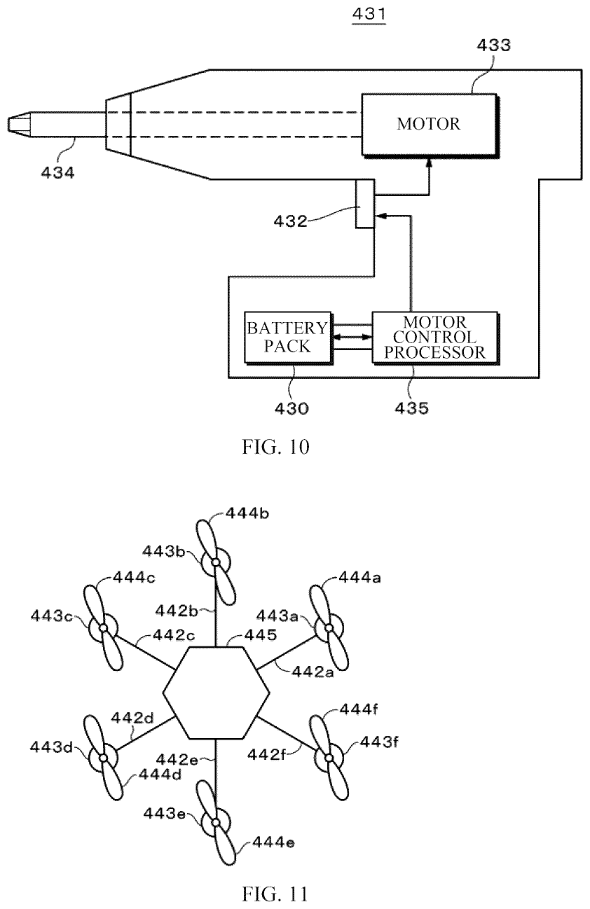

An example of an electric screwdriver as an electric tool to which the secondary battery of an embodiment of the present disclosure is applicable will be schematically described with reference to FIG. 10. An electric screwdriver 431 has a body in which a motor 433 such as a DC motor is contained. Rotation of the motor 433 is transmitted to a shaft 434, and the shaft 434 drives a screw into a target object. The electric screwdriver 431 is provided with a trigger switch 432 to be operated by a user.

A battery pack 430 and a motor control processor 435 are contained in a lower housing of a handle of the electric screwdriver 431. The battery pack 300 is usable as the battery pack 430. The motor control processor 435 controls the motor 433. Components of the electric screwdriver 431 other than the motor 433 may each be controlled by the motor control processor 435. The battery pack 430 and the electric screwdriver 431 are engaged with each other by respective engaging members provided in the battery pack 430 and the electric screwdriver 431. As will be described later, the battery pack 430 and the motor control processor 435 include respective microcomputers. Battery power is supplied from the battery pack 430 to the motor control processor 435, and the respective microcomputers of the battery pack 430 and the motor control processor 435 communicate with each other to transmit and receive data on the battery pack 430.

The battery pack 430 is, for example, detachably attached to the electric screwdriver 431. The battery pack 430 may be built in the electric screwdriver 431. The battery pack 430 is mounted on a charging device when charging is performed. When the battery pack 430 is mounted on the electric screwdriver 431, a portion of the battery pack 430 may be exposed to the outside of the electric screwdriver 431 to allow the exposed portion to be visible to the user. For example, the exposed portion of the battery pack 430 may be provided with an LED to make it possible for the user to check light emission and extinction of the LED.

The motor control processor 435 controls, for example, rotation and stopping of the motor 433 and a rotation direction of the motor 433. Furthermore, the motor control processor 435 blocks power supply to a load upon overdischarging. For example, the trigger switch 432 is interposed between the motor 433 and the motor control processor 435. Upon pressing of the trigger switch 432 by the user, power is supplied to the motor 433 to cause the motor 433 to rotate. Upon returning of the trigger switch 432 by the user, the rotation of the motor 433 stops.

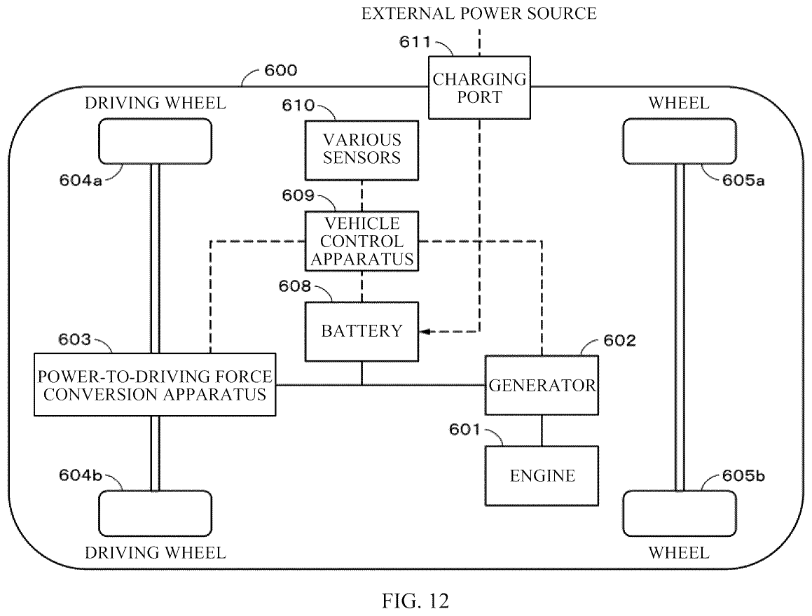

An example in which the secondary battery of an embodiment of the present disclosure is applied to a power source for an electric aircraft will be described with reference to FIG. 11. The secondary battery of an embodiment of the present disclosure is applicable as a power source for an unmanned aircraft such as a drone. FIG. 11 is a plan view of the unmanned aircraft. The unmanned aircraft has an airframe including a fuselage part of a circular cylindrical or rectangular cylindrical shape as a center part, and support shafts 442a to 442f fixed to an upper portion of the fuselage part. In FIG. 11, the fuselage part has a hexagonal cylindrical shape with six support shafts 442a to 442f extending radially from a center of the fuselage part at equal angular intervals. The fuselage part and the support shafts 442a to 442f each include a lightweight and high-strength material.

Motors 443a to 443f as drive sources for rotary wings are attached to respective tip parts of the support shafts 442a to 442f. Rotary wings 444a to 444f are attached to respective rotary shafts of the motors 443a to 443f. A circuit unit 445 including a motor control circuit for controlling each motor is attached to the center part, i.e., the upper portion of the fuselage part, at which the support shafts 442a to 442f intersect.

Further, a battery unit as a power source is disposed at a position below the fuselage part. The battery unit includes three battery packs to supply electric power to pairs of motors and rotary wings that have an opposing interval of 180 degrees. Each battery pack includes, for example, a lithium-ion secondary battery and a battery control circuit that controls charging and discharging. The battery pack 300 is usable as the battery pack. A combination of the motor 443a and the rotary wing 444a and a combination of the motor 443d and the rotary wing 444d pair up with each other. Similarly, a combination of the motor 443b and the rotary wing 444b and a combination of the motor 443e and the rotary wing 444e pair up with each other; and a combination of the motor 443c and the rotary wing 444c and a combination of the motor 443f and the rotary wing 444f pair up with each other. The number of these pairs and the number of the battery packs are set to be equal.

An example in which the secondary battery of an embodiment of the present disclosure is applied to a power storage system for an electric vehicle will be described with reference to FIG. 12. FIG. 12 schematically illustrates an example of a configuration of a hybrid vehicle that employs a series hybrid system to which the secondary battery of an embodiment of the present disclosure is applicable. The series hybrid system relates to a vehicle that travels with a power-to-driving-force conversion apparatus, using electric power generated by a generator driven by an engine or using electric power temporarily stored in a battery.

A hybrid vehicle 600 is equipped with an engine 601, a generator 602, a power-to-driving-force conversion apparatus 603, a driving wheel 604a, a driving wheel 604b, a wheel 605a, a wheel 605b, a battery 608, a vehicle control apparatus 609, various sensors 610, and a charging port 611. The battery pack 300 of an example embodiment of the present disclosure described above is applicable to the battery 608.

The hybrid vehicle 600 travels with the power-to-driving-force conversion apparatus 603 as a power source. An example of the power-to-driving-force conversion apparatus 603 is a motor. The power-to-driving-force conversion apparatus 603 operates under electric power of the battery 608, and a rotational force of the power-to-driving-force conversion apparatus 603 is transmitted to the driving wheels 604a and 604b. Note that both an alternating-current motor and a direct-current motor are applicable as the power-to-driving-force conversion apparatus 603 by using direct-current-to-alternating-current (DC-to-AC) conversion or reverse conversion (AC-to-DC conversion) at a location where such conversion is necessary. The various sensors 610 control an engine speed via the vehicle control apparatus 609, and control an opening angle, i.e., a throttle position, of an unillustrated throttle valve. The various sensors 610 include, for example, a speed sensor, an acceleration sensor, and an engine speed sensor.

A rotational force of the engine 601 is transmitted to the generator 602, and electric power generated by the generator 602 from the rotational force is storable in the battery 608. When the hybrid vehicle 600 is decelerated by an unillustrated brake mechanism, a resistance force at the time of deceleration is applied to the power-to-driving-force conversion apparatus 603 as a rotational force, and regenerative electric power generated by the power-to-driving-force conversion apparatus 603 from the rotational force is stored in the battery 608.

Coupling the battery 608 to a power source outside the hybrid vehicle 600 allows the battery 608 to be supplied with electric power from the external power source via the charging port 611 as an input port, and to store the supplied electric power.

Further, the hybrid vehicle 600 may include a data processing apparatus that performs data processing related to vehicle control, based on data related to the secondary battery. Non-limiting examples of such a data processing apparatus include a data processing apparatus that indicates a remaining battery level, based on data related to the remaining level of the battery.

The description above has dealt with, as an example, a series hybrid vehicle which travels by means of the motor using electric power generated by the generator driven by the engine, or using electric power temporarily stored in the battery. However, the secondary battery of an embodiment of the present disclosure is also effectively applicable to a parallel hybrid vehicle which uses outputs of both an engine and a motor as driving sources and appropriately switches between three traveling modes, i.e., traveling only by means of the engine, traveling only by means of the motor, and traveling by means of the engine and the motor. Furthermore, the secondary battery of an embodiment of the present disclosure is also effectively applicable to what is called an electric vehicle that travels by being driven by only a driving motor without the use of an engine.

### EXAMPLES

Examples of an embodiment of the present disclosure will be described in further detail below.

### Example 1

As described below, the secondary battery 1 of the cylindrical type illustrated in, for example, FIG. 1 was fabricated, and was thereafter evaluated for its battery characteristic. Here, the secondary battery 1 was fabricated with dimensions of 21.2 mm in diameter and 70 mm in length.

### [Fabrication Method]

First, an aluminum foil having a thickness of 12 μm was prepared as the positive electrode current collector 21A. Thereafter, a layered lithium oxide as the positive electrode active material was mixed with a positive electrode binder and a conductive additive. The layered lithium oxide included lithium nickel cobalt aluminum oxide (NCA) having a Ni ratio of 85% or greater. The positive electrode binder included polyvinylidene difluoride. The conductive additive included a mixture of carbon black, acetylene black, and Ketjen black. A positive electrode mixture was thereby obtained. A mixture ratio between the positive electrode active material, the positive electrode binder, and the conductive additive was set to 96.4:2:1.6. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on respective predetermined regions of the two opposite surfaces of the positive electrode current collector 21A by means of a coating apparatus, following which the applied positive electrode mixture slurry was dried to thereby form the positive electrode active material layers 21B. Further, a coating material including polyvinylidene difluoride (PVDF) was applied on surfaces of the positive electrode exposed part 212, at respective regions adjacent to the positive electrode covered part 211. The applied coating material was dried to thereby form the insulating layers 101 each having a width of 3 mm and a thickness of 8 μm. Thereafter, the positive electrode active material layers 21B were compression-molded by means of a roll pressing machine. The positive electrode 21 including the positive electrode covered part 211 and the positive electrode exposed part 212 was thus obtained. Here, the positive electrode covered part 211 was set to 60 mm in width in the W-axis direction, and the positive electrode exposed part 212 was set to 7 mm in width in the W-axis direction. Further, a length of the positive electrode 21 in the L-axis direction was set to 1700 mm. In the positive electrode 21 thus obtained, the positive electrode active material layer 21B had an area density of 22.0 mg/cm² and a volume density of 3.55 g/cm³. The thickness T1 of the positive electrode covered part 211 was 74.2 μm.

Further, a copper foil having a thickness of 8 μm was prepared as the negative electrode current collector 22A. Thereafter, the negative electrode active material in which a carbon material and SiO were mixed at a weight ratio of 93.75:6.25 was mixed with a negative electrode binder and a conductive additive. The carbon material included natural graphite. The negative electrode binder included polyvinylidene difluoride. The conductive additive included a mixture of carbon black, acetylene black, and Ketjen black. A negative electrode mixture was thereby obtained. A mixture ratio between the negative electrode active material, the negative electrode binder, and the conductive additive was set to 96.1:2.9:1.0. Further, a mixture ratio between graphite and SiO in the negative electrode active material was set to 95:5. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on respective predetermined regions of the two opposite surfaces of the negative electrode current collector 22A by means of a coating apparatus, following which the applied negative electrode mixture slurry was dried to thereby form the negative electrode active material layers 22B. Thereafter, the negative electrode active material layers 22B were compression-molded by means of a roll pressing machine. The negative electrode 22 including the negative electrode covered part 221 and the negative electrode exposed part 222 was thus obtained. Here, the negative electrode covered part 221 was set to 62 mm in width in the W-axis direction, and the first region 222A of the negative electrode exposed part 222 was set to 4 mm in width in the W-axis direction. Further, a length of the negative electrode 22 in the L-axis direction was set to 1750 mm. In the negative electrode 22 thus obtained, the negative electrode active material layer 22B had an area density of 10.82 mg/cm² and a volume density of 1.50 g/cm³. The negative electrode covered part 221 had a thickness of 80.1 μm.

Thereafter, the positive electrode 21 and the negative electrode 22 were stacked, with the first separator member 23A and the second separator member 23B on the positive electrode 21 and the negative electrode 22, respectively, to cause the positive electrode exposed part 212 and the first region 222A of the negative electrode exposed part 222 to be on opposite sides to each other in the W-axis direction. The stacked structure S20 was thereby fabricated. At this time, the stacked structure S20 was fabricated not to allow the positive electrode active material layers 21B to protrude from the negative electrode active material layers 22B in the W-axis direction. As each of the first separator member 23A and the second separator member 23B, used was a polyethylene sheet having a width of 65 mm and a thickness of 14 μm. In fabricating the stacked structure S20, the inner winding side end part of the first separator member 23A and the inner winding side end part of the second separator member 23B were folded back, and these inner winding side end parts were caused to be interposed between the inner winding side edge 21E2 of the positive electrode 21 and the negative electrode 22. Thereafter, the stacked structure S20 was so wound in a spiral shape as to form the through hole 26, and the fixing tape 46 was attached to the outermost wind of the stacked structure S20 thus wound. The electrode wound body 20 was thereby obtained. Note that the electrode wound body 20 thus obtained had an outer diameter of 20.55 mm. Here, a maximum outer diameter and a minimum outer diameter of the electrode wound body 20 were each measured with “Magnescale U30B-J” and “Gauge Stand DZ521” available from Sony Corporation, located in Tokyo, Japan, and an average of the measured values was calculated as the outer diameter of the electrode wound body 20.

Thereafter, the end faces 41 and 42 of the electrode wound body 20 were locally bent by pressing an end of a 0.5-mm-thick flat plate against each of the end faces 41 and 42 in the Z-axis direction. The grooves 43 extending radiately in the radial directions (the R directions) from the through hole 26 were thereby formed.

Thereafter, substantially equal pressures were applied to the end faces 41 and 42 substantially perpendicularly from above and below the electrode wound body 20 at substantially the same time. The positive electrode exposed part 212 and the first region 222A of the negative electrode exposed part 222 were thereby bent to make the end faces 41 and 42 into flat surfaces. At this time, the first edge parts 212E of the positive electrode exposed part 212 located at the end face 41 were caused to bend toward the through hole 26 while overlapping each other, and the second edge parts 222E of the negative electrode exposed part 222 located at the end face 42 were caused to bend toward the through hole 26 while overlapping each other. Thereafter, the fan-shaped part 31 of the positive electrode current collector plate 24 was joined to the end face 41 by laser welding, and the fan-shaped part 33 of the negative electrode current collector plate 25 was joined to the end face 42 by laser welding.

Thereafter, the insulating tapes 53 and 54 were attached to the predetermined locations on the electrode wound body 20, following which the band-shaped part 32 of the positive electrode current collector plate 24 was bent and inserted through the hole 12H of the insulating plate 12, and the band-shaped part 34 of the negative electrode current collector plate 25 was bent and inserted through the hole 13H of the insulating plate 13.

Thereafter, the electrode wound body 20 having been assembled in the above-described manner was placed into the outer package can 11, following which the bottom part of the outer package can 11 and the negative electrode current collector plate 25 were welded to each other. Thereafter, the narrow part was formed in the vicinity of the open end part 11N of the outer package can 11. Further, the electrolytic solution was injected into the outer package can 11, following which the band-shaped part 32 of the positive electrode current collector plate 24 and the safety valve mechanism 30 were welded to each other.

As the electrolytic solution, used was a solution including a solvent prepared by adding fluoroethylene carbonate (FEC) and succinonitrile (SN) to a major solvent, i.e., ethylene carbonate (EC) and dimethyl carbonate (DMC), and including LiBF₄ and LiPF₆ as the electrolyte salt. In the lithium-ion secondary battery of the present example, a content ratio (wt %) between EC, DMC, FEC, SN, LiBF₄, and LiPF₆ in the electrolytic solution was set to 12.7:56.2:12.0:1.0:1.0:17.1.

Lastly, sealing was performed with the gasket 15, the safety valve mechanism 30, and the battery cover 14, through the use of the narrow part.

The secondary battery 1 of Example 1 was thus obtained. Here, a ratio T2/T1 of the thickness T2 of the thick part 11S2 to the thickness T1 of the thin part 11S1 was set to 145%, a ratio IR1/IR2 of the inner diameter IR1 to the inner diameter IR2 was set to 100.87%, the width W-LAP of the overlap part LAP was set to 3.0 mm, and the ratio W-LAP/W-21B of the width W-LAP to the width W-21B of the positive electrode active material layer 21B was set to 5.1%. The inner diameter IR1 of the thin part 11S1 was set to 20.80 mm. The inner diameter IR2 of the thick part 11S2 was set to 20.62 mm. Note that a measurement position of the inner diameter IR1 of the thin part 11S1 was set to 2 mm±1 mm below the thick part 11S2. The inner diameters IR and IR2 were measured in the following manner.
(1) The secondary battery was left to stand with a resistance of 1Ω for 24 hours, and was thus discharged until an open circuit voltage OCV reached 0.3 V or below.
(2) The secondary battery thus discharged was sealed in a resin available as Epomount B-set from Refine Tec Ltd., located in Kanagawa, Japan.
(3) The secondary battery sealed in the resin was cut along the radial direction with IsoMet 1000 available from Buehler, located in Ill., U.S. to form a cut surface orthogonal to the height direction.
(4) The cut surface was polished with Automet 250 available from Buehler, located in Ill., U.S.
(5) The cut surface thus polished was observed with VR-3200 available from Keyence Corporation, located in Osaka, Japan, and the inner diameters IR1 and IR2 were measured by circular approximation through three-point plotting.

### [Evaluation of Battery Characteristic]

Evaluation of the battery characteristic of the secondary battery 1 of Example 1 obtained in the above-described manner revealed the results presented in Table 1. Specifically, the following were performed: checking of precipitation of lithium after initial charging, checking of the presence of any uncharged part after the initial charging, measurement of an initial capacity [mAh], a cycle test to count the number of cycles before a decrease in capacity to 70%, and checking of breakage of the electrode(s) after the cycle test. The initial charging, the measurement of the initial capacity, and the cycle test were each performed at an ambient temperature of 23° C.±1° C. The results of the battery characteristic evaluation are presented in Table 1.

TABLE 1

| | SiO [%] | Thick part | | | | W-LAP/ | Precipi- | | Initial | Number of | |
|---|---|---|---|---|---|---|---|---|---|---|---|
| | in negative | in outer | T2/T1 | IR1/IR2 | W-LAP | W-21B | tation | Uncharged | capacity | cycles before | Electrode |
| | electrode | package can | [%] | [%] | [mm] | [%] | of Li | part | mAh | reaching 70% | breakage |
| Example 1 | 6.25 | Present | 145 | 100.87 | 3.0 | 5.1 | No | No | 4150 | 350 | No |
| Example 2 | 6.25 | Present | 145 | 100.87 | 0.5 | 0.8 | No | No | 4150 | 340 | No |
| Example 3 | 6.25 | Present | 145 | 100.87 | 5.0 | 8.5 | No | No | 4150 | 330 | No |
| Example 4 | 6.25 | Present | 110 | 100.19 | 3.0 | 5.1 | No | No | 4150 | 340 | No |
| Example 5 | 6.25 | Present | 180 | 101.56 | 3.0 | 5.1 | No | No | 4150 | 330 | No |
| Example 6 | 6.25 | Present | 145 | 100.87 | 6.0 | 10.2 | No | No | 4150 | 290 | No |
| Example 7 | 6.25 | Present | 105 | 100.10 | 3.0 | 5.1 | No | Yes | 4150 | 280 | No |
| Example 8 | 6.25 | Present | 190 | 101.76 | 3.0 | 5.1 | No | No | 4150 | 200 | Yes |
| Example 9 | 16.0 | Present | 145 | 100.87 | 3.0 | 5.1 | No | No | 4500 | 180 | Yes |
| Example 10 | 3.0 | Present | 145 | 100.87 | 3.0 | 5.1 | No | No | 3950 | 360 | No |
| Example 11 | 2.0 | Present | 145 | 100.87 | 3.0 | 5.1 | No | No | 3850 | 370 | No |
| Comparative | 6.25 | Present | 145 | 100.87 | 0.0 | 0 | Yes | Yes | 4150 | 270 | No |
| example 1 | | | | | | | | | | | |
| Comparative | 6.25 | Absent | 100 | — | — | — | Yes | Yes | 4150 | 250 | No |
| example 2 | | | | | | | | | | | |

As the initial charging, constant current and constant voltage (CC-CV) charging was performed. The secondary battery was charged with a constant current of 4.0 A to a voltage of 4.2 V, and was thereafter charged with a constant voltage of 4.2 V. A cutoff current was set to 0.05 A. The secondary battery after the initial charging was disassembled, and an electrode surface was visually inspected to determine whether precipitation of lithium had occurred and whether any uncharged part was present. The precipitation of lithium refers to a state where lithium metal precipitated on the surface of the negative electrode. The presence of the uncharged part refers to a state where a region of the negative electrode opposed to the positive electrode included a portion that was uncharged.

The initial capacity [mAh] was determined in the following manner. First, constant current and constant voltage (CC-CV) charging was performed. Specifically, charging was performed with a constant current of 4.0 A to a voltage of 4.2 V, following which charging was performed with a constant voltage of 4.2 V. A cutoff current was set to 0.05 A. Thereafter, constant current (CC) discharging was performed. Specifically, discharging was performed with a constant current of 0.8 A. A cutoff voltage was set to 2.0 V.

Test conditions for the cycle test were as follows.
(1) Charge conditions: Constant current and constant voltage (CC-CV) charging was performed. Charging was performed with a constant current of 6 A to a voltage of 4.2 V, following which charging was performed with a constant voltage of 4.2 V. A cutoff current was set to 1 A.
(2) Rest time after charging: 30 minutes.
(3) Discharge conditions: Constant current (CC) discharging was performed with a constant current of 50 A. A cutoff voltage was set to 2.5 V, or discharging was stopped when a temperature reached 85° C.
(4) Rest after discharging: A rest was taken until a battery surface temperature fell below 30° C.
(5) Number of cycles: The number of cycles needed to cause the capacity of the secondary battery to decrease to 70% of the initial capacity was investigated.

The checking of breakage of the electrode(s) after the cycle test was carried out in the following manner. First, the secondary battery after the cycle test was disassembled to separate the positive electrode and the negative electrode from each other. Thereafter, the positive electrode and the negative electrode were each visually inspected from a back side, while being irradiated with light from a front side. At this time, if leakage light was observed on the back side, it was determined that a portion of the positive electrode or a portion of the negative electrode was cracked, and it was therefore determined that breakage of the electrode(s) had occurred.

### Examples 2 to 8

Secondary batteries were each fabricated in a manner similar to that in Example 1, except that T2/T1, IR1/IR2, W-LAP, and W-LAP/W-21B were set to respective values listed in Table 1. The fabricated secondary batteries were each subjected to evaluation similar to that performed on Example 1. The results are also presented in Table 1. Note that in Examples 4, 5, 7, and 8, the inner diameters IR1 of the thin parts 11S1 were each set to 20.80 mm as in Example 1, and the inner diameters IR2 of the thick parts 11S2 were changed to thereby vary the ratios IR1/IR2.

### Examples 9 to 11

Secondary batteries were fabricated in a manner similar to that in Example 1, except that the weight ratios of SiO included in the negative electrode active materials were set to respective values listed in Table 1, in other words, energy densities of the negative electrode active materials were varied. The fabricated secondary batteries were each subjected to evaluation similar to that performed on Example 1. The results are also presented in Table 1. Note that changing the weight ratio of SiO included in the negative electrode active material results in a change in thickness of the negative electrode 22. Accordingly, if conditions relating to the lengths of the positive electrode 21 and the negative electrode 22 in the L-axis direction remain similar to those of Example 1, a difference in outer diameter of the electrode wound body 20 would result, as compared with Example 1. To address this, in each of Examples 9 to 11, with design conditions for the positive electrode 21 being allowed to remain unchanged from those in Example 1, the length of each of the positive electrode 21 and the negative electrode 22 in the L-axis direction was adjusted to thereby maintain the outer diameter of the electrode wound body 20 at a similar value to that in Example 1. Specifically, in Example 9 in which the weight ratio of SiO was 16%, the length of the positive electrode 21 in the L-axis direction was changed to 1915 mm, and the length of the negative electrode 22 in the L-axis direction was changed to 1975 mm. In Example 10 in which the weight ratio of SiO was 3%, the length of the positive electrode 21 in the L-axis direction was changed to 1600 mm, and the length of the negative electrode 22 in the L-axis direction was changed to 1660 mm. In Example 11 in which the weight ratio of SiO was 2%, the length of the positive electrode 21 in the L-axis direction was changed to 1560 mm, and the length of the negative electrode 22 in the L-axis direction was changed to 1620 mm.

### Comparative Example 1

A secondary battery was fabricated in a manner similar to that in Example 1, except that the width W-LAP of the overlap part LAP was set to 0. The fabricated secondary battery was subjected to evaluation similar to that performed on Example 1. The results are also presented in Table 1.

### Comparative Example 2

A secondary battery was fabricated in a manner similar to that in Example 1, except for using an outer package can without the thick part, that is, an outer package can with a sidewall part having a constant thickness. The fabricated secondary battery was subjected to evaluation similar to that performed on Example 1. The results are also presented in Table 1.

As indicated in Table 1, it was found that Examples 1 to 11 each made it possible to suppress precipitation of lithium on the surface of the negative electrode 22. Further, no uncharged part was observed in the negative electrode 22 in any of Examples 1 to 6 and 8 to 11. In contrast, in each of Comparative examples 1 and 2, precipitation of lithium and the unchanged part were both observed. It was confirmed that the occurrence of precipitation of lithium and the presence of the uncharged part in each of Comparative examples 1 and 2 were due to an increased distance between the outermost positive electrode wind part 21out and the outermost negative electrode wind part 22out. In contrast, for Examples 1 to 11, it is considered that the presence of the overlap part LAP allowed the outermost positive electrode wind part 21out and the outermost negative electrode wind part 22out to be kept at an appropriate distance from each other, which made it possible to prevent precipitation of lithium on the surface of the negative electrode 22. Lithium metal is known to be very high in reactivity, and to be low in thermal stability. The precipitation of lithium metal on the negative electrode 22 would lead to concern about degradation in safety of the secondary battery. Each of Examples 1 to 11, however, suppressed the precipitation of lithium on the surface of the negative electrode 22, which indicates that the secondary battery achieved high safety. Further, comparing Examples 1 to 8 with Comparative examples 1 and 2 indicates that substantially the same initial capacities are obtainable if the energy densities of the negative electrode active materials are the same and the lengths of the negative electrodes in the L-axis direction are also the same.

In Example 7, no precipitation of lithium on the surface of the negative electrode 22 was observed; however, a small uncharged part was observed. A reason for this is considered to be that the low ratio T2/T1 of 105% led to a low strength to retain the distance between the outermost positive electrode wind part 21out and the outermost negative electrode wind part 22out, as compared with the other Examples.

From the results on Examples 1 to 11, it was found that setting the thickness T2 of the thick part 11S2 within the range from 110% to 180%, both inclusive, of the thickness T1 of the thin part 11S1 made it possible to achieve favorable effects. For example, based on comparisons of Example 7 with Examples 1 to 6 and 8, it was found that setting the ratio T2/T1 to 110% or greater made it possible to sufficiently suppress an increase in distance between the outermost positive electrode wind part 21out and the outermost negative electrode wind part 22out, and accordingly made it possible to more effectively prevent the precipitation of lithium on the surface of the negative electrode 22. Further, based on comparisons of Example 8 with Examples 1 to 7, it was found that setting the ratio T2/T1 to 180% or less made it possible to achieve a favorable cyclability characteristic. A reason why the favorable cyclability characteristic was achieved is considered to be that, owing to the positive electrode 21 and the negative electrode 22 being biased with appropriate strength by the thick part 11S2, the electrolytic solution was sufficiently distributed into the negative electrode active material, which contributed to ensuring of favorable ion conductivity.

Further, based on comparisons of Example 5 with Example 8, it was found that the ratio T2/T1 exceeding 180% resulted in breakage of the electrode(s). This is presumably because the inner diameter IR2 of the thick part 11S2 became excessively small, which resulted in an increase in force applied to the positive electrode 21 and the negative electrode 22 upon repeated charging and discharging.

Further, based on comparisons of Example 6 with Examples 1 to 5, it was found that setting the width W-LAP of the overlap part LAP within the range from 0.5 mm to 5.0 mm both inclusive, that is, setting the ratio W-LAP/W-21B within the range from 0.8% to 8.5% both inclusive, made it possible to achieve a favorable cyclability characteristic.

Moreover, based on comparisons between Examples 1 and 9 to 11, it was confirmed that when the ratio of the weight of SiO to the total weight of graphite and SiO in the negative electrode active material was within the range from 3 wt % to 15 wt % both inclusive, a sufficient initial capacity and a favorable cyclability characteristic were both achieved without causing breakage of the electrode(s).

As another approach to suppressing an increase in distance between the outermost positive electrode wind part 21out and the outermost negative electrode wind part 22out, for example, a portion of the separator 23 located on the outermost wind side of the electrode wound body 20 may be extended in length, and the extended portion of the separator 23 may be wrapped multiple times around an outermost wind surface of the electrode wound body 20. Alternatively, the fixing tape 46 on the outermost wind of the electrode wound body 20 may be made larger in width and also extended in length, and the extended portion of the fixing tape 46 may be wrapped multiple times around the outermost wind surface of the electrode wound body 20. However, in such a case, it is necessary to maintain the outer diameter of the electrode wound body 20 at a similar value to that in Example 1 by adjusting the respective lengths of the positive electrode 21 and the negative electrode 22 in the L-axis direction, while extending the separator 23 or the fixing tape 46 in length. This would result in a decreased initial capacity relative to the initial capacity of Example 1. Furthermore, simply wrapping the extended portion of the separator 23 or the extended portion of the fixing tape 46 multiple times around the outermost wind surface of the electrode wound body 20 would not be enough to sufficiently suppress an increase in distance between the outermost positive electrode wind part 21out and the outermost negative electrode wind part 22out caused by expansion and contraction of the negative electrode 22 occurring upon charging and discharging, and would thus result in some uncharged part.

Although the present technology has been described hereinabove with reference to an embodiment including Examples, a configuration of an embodiment of the present technology is not limited thereto, and is therefore modifiable in a variety of suitable ways.

For example, in the foregoing, the description has been given of the case where the electrode reactant is lithium; however, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of an embodiment of the present technology are therefore not limited to those described herein. Accordingly, the present technology may achieve any other effect.

Furthermore, the present disclosure encompasses any possible combination of some or all of the various embodiments including the modification examples described herein and incorporated herein.

It is possible to achieve at least the following configurations from the foregoing embodiments including modification examples of the present disclosure.

(1)

A secondary battery including:
an electrode wound body including a stacked structure wound around a central axis extending in a first direction, the stacked structure including a first electrode and a second electrode that are stacked with a separator interposed between the first electrode and the second electrode;
a first electrode current collector plate disposed to face a first end face of the electrode wound body, the first end face being in the first direction;
a second electrode current collector plate disposed to face a second end face of the electrode wound body, the second end face being opposite to the first end face in the first direction;
an electrolytic solution; and
a battery can including a bottom part and a sidewall part, and containing the electrode wound body, the first electrode current collector plate, the second electrode current collector plate, and the electrolytic solution, the bottom part of the battery can being opposed to the second end face with the second electrode current collector plate interposed between the bottom part and the second end face, the sidewall part of the battery can standing on the bottom part to surround the electrode wound body, in which
the first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate,
the second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate,
in the electrode wound body, an outermost wind part of the second electrode is located on an outer side relative to an outermost wind part of the first electrode,
the sidewall part of the battery can includes a thin part and a thick part, the thick part protruding toward an inner side of the battery can along a radial direction of the electrode wound body, the radial direction being orthogonal to the first direction, and
the thick part is located to overlap, in the radial direction, an end part of the first electrode covered part, the end part being located on a side of the first end face in the first direction.
   (2)

The secondary battery according to (1), in which the first electrode includes a positive electrode, and the second electrode includes a negative electrode.

(3)

The secondary battery according to (1) or (2), in which the thick part has a thickness in the radial direction greater than a thickness of the thin part in the radial direction.

(4)

The secondary battery according to (3), in which the thickness of the thick part in the radial direction is greater than or equal to 110 percent and less than or equal to 180 percent of the thickness of the thin part in the radial direction.

(5)

The secondary battery according to any one of (1) to (4), in which the thin part has an inner diameter greater than or equal to 100.19 percent and less than or equal to 100.87 percent of an inner diameter of the thick part.

(6)

The secondary battery according to any one of (1) to (5), in which an overlap part in which the thick part and the first electrode covered part overlap each other has a length in the first direction greater than or equal to 0.5 millimeters and less than or equal to 5.0 millimeters.

(7)

The secondary battery according to any one of (1) to (6), in which a ratio of the length, in the first direction, of the overlap part in which the thick part and the first electrode covered part overlap each other to a length, in the first direction, of the first electrode covered part is greater than or equal to 0.8 percent and less than or equal to 8.5 percent.

(8)

The secondary battery according to any one of (1) to (7), in which
the second electrode includes a negative electrode, and the second electrode active material layer includes a negative electrode active material layer, and
the negative electrode active material layer includes graphite and SiO as a negative electrode active material.
   (9)

The secondary battery according to (8), wherein a ratio of a weight of the SiO to a total weight of the graphite and the SiO in the negative electrode active material is greater than or equal to 3 weight percent and less than or equal to 15 weight percent.

(10)

The secondary battery according to any one of (1) to (9), in which
the first electrode includes a positive electrode, the first electrode current collector comprises a positive electrode current collector, the first electrode active material layer includes a positive electrode active material layer, the first electrode current collector plate includes a positive electrode current collector plate, the first electrode covered part includes a positive electrode covered part, and the first electrode exposed part includes a positive electrode exposed part; and
the second electrode includes a negative electrode, the second electrode current collector includes a negative electrode current collector, the second electrode active material layer includes a negative electrode active material layer, the second electrode current collector plate includes a negative electrode current collector plate, the second electrode covered part includes a negative electrode covered part, and the second electrode exposed part includes a negative electrode exposed part.
   (11)

The secondary battery according to (10), in which, in the positive electrode, the positive electrode current collector is covered with the positive electrode active material layer from an outer winding side edge of the positive electrode to an inner winding side edge of the positive electrode in a winding direction of the electrode wound body.

(12)

The secondary battery according to any one of (1) to (11), in which
the separator includes a porous film as a base, the porous film including polyolefin,
the porous film has a thickness greater than or equal to 10 micrometers and less than or equal to 15 micrometers, and
the porous film has a surface density greater than or equal to 6.3 grams per square meter and less than or equal to 8.3 grams per square meter.
   (13)

The secondary battery according to any one of (1) to (12), in which the first electrode exposed part wound around the central axis includes first edge parts that are adjacent to each other in the radial direction of the electrode wound body, the first edge parts being bent toward the central axis to overlap each other.

(14)

The secondary battery according to any one of (1) to (13), in which the second electrode exposed part wound around the central axis includes second edge parts that are adjacent to each other in the radial direction of the electrode wound body, the second edge parts being bent toward the central axis to overlap each other.

(15)

The secondary battery according to any one of (1) to (14), in which the first electrode active material layer includes a positive electrode active material including at least one of lithium cobalt oxide, lithium nickel cobalt manganese oxide, or lithium nickel cobalt aluminum oxide.

(16)

A battery pack including:
the secondary battery according to any one of (1) to (15);
a processor configured to control the secondary battery; and
an outer package body containing the secondary battery.
   (17)

An electric vehicle including:
the secondary battery according to any one of (1) to (15);
a converter configured to convert electric power suppled from the secondary battery into a driving force;
a drive unit configured to perform driving in accordance with the driving force; and
a processor configured to control operation of the secondary battery.
   (18)

An electric aircraft including:
the battery pack according to (16);
a plurality of rotary wings;
a motor configured to rotate each of the rotary wings;
a support shaft supporting each of the rotary wings and the motor;
a motor control processor configured to control rotation of the motor; and
an electric power supply line configured to supply electric power to the motor, in which the battery pack is coupled to the electric power supply line.
   (19)

An electric tool including:
the secondary battery according to any one of (1) to (15); and
a movable part configured to receive electric power from the secondary battery.
   (20)

Electronic equipment including
the secondary battery according to any one of (1) to (15) as an electric power supply source.

In a secondary battery according to an embodiment of the present disclosure, and a battery pack, electronic equipment, an electric tool, an electric aircraft, and an electric vehicle that each include the secondary battery according to an embodiment of the present disclosure, a thick part of a battery can and an end part, of a first electrode covered part, located on a side of a first end face of an electrode wound body are in a mutually overlapping positional relation in a radial direction. Accordingly, a region in the vicinity of the first end face is biased by the thick part along the radial direction toward a central axis. As a result, it is possible to suppress an increase in distance between an end part of an outermost wind part of a first electrode and an end part of an outermost wind part of a second electrode. This makes it possible to achieve high safety.

Note that effects of an embodiment of the present technology are not necessarily limited to those described herein and may include any of a series of effects described in relation to an embodiment of the present technology.

Although the present disclosure has been described hereinabove in terms of an embodiment including modification examples, the present disclosure is not limited thereto. It is to be appreciated that variations may be made in the described embodiment including modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated member, integer or step but not the exclusion of any other non-stated member, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked structure wound around a central axis extending in a first direction, the stacked structure including a first electrode and a second electrode that are stacked with a separator interposed between the first electrode and the second electrode;
a first electrode current collector plate disposed to face a first end face of the electrode wound body, the first end face being in the first direction;
a second electrode current collector plate disposed to face a second end face of the electrode wound body, the second end face being opposite to the first end face in the first direction;
an electrolytic solution; and
a battery can including a bottom part and a sidewall part, and containing the electrode wound body, the first electrode current collector plate, the second electrode current collector plate, and the electrolytic solution, the bottom part of the battery can being opposed to the second end face with the second electrode current collector plate interposed between the bottom part and the second end face, the sidewall part of the battery can standing on the bottom part to surround the electrode wound body, wherein
the first electrode includes a first electrode covered part in which a first electrode current collector is covered with a first electrode active material layer, and a first electrode exposed part in which the first electrode current collector is exposed without being covered with the first electrode active material layer, and in which the first electrode current collector is joined to the first electrode current collector plate,
the second electrode includes a second electrode covered part in which a second electrode current collector is covered with a second electrode active material layer, and a second electrode exposed part in which the second electrode current collector is exposed without being covered with the second electrode active material layer, and in which the second electrode current collector is joined to the second electrode current collector plate,
in the electrode wound body, an outermost wind part of the second electrode is located on an outer side relative to an outermost wind part of the first electrode,
the sidewall part of the battery can includes a thin part and a thick part, the thick part protruding toward an inner side of the battery can along a radial direction of the electrode wound body, the radial direction being orthogonal to the first direction, and
the thick part is located to overlap, in the radial direction, an end part of the first electrode covered part, the end part being located on a side of the first end face in the first direction.

2. The secondary battery according to claim 1, wherein the first electrode comprises a positive electrode, and the second electrode comprises a negative electrode.

3. The secondary battery according to claim 1, wherein the thick part has a thickness in the radial direction greater than a thickness of the thin part in the radial direction.

4. The secondary battery according to claim 3, wherein the thickness of the thick part in the radial direction is greater than or equal to 110 percent and less than or equal to 180 percent of the thickness of the thin part in the radial direction.

5. The secondary battery according to claim 1, wherein the thin part has an inner diameter greater than or equal to 100.19 percent and less than or equal to 100.87 percent of an inner diameter of the thick part.

6. The secondary battery according to claim 1, wherein an overlap part in which the thick part and the first electrode covered part overlap each other has a length in the first direction greater than or equal to 0.5 millimeters and less than or equal to 5.0 millimeters.

7. The secondary battery according to claim 1, wherein a ratio of the length, in the first direction, of the overlap part in which the thick part and the first electrode covered part overlap each other to a length, in the first direction, of the first electrode covered part is greater than or equal to 0.8 percent and less than or equal to 8.5 percent.

8. The secondary battery according to claim 1, wherein
the second electrode comprises a negative electrode, and the second electrode active material layer comprises a negative electrode active material layer, and
the negative electrode active material layer includes graphite and SiO as a negative electrode active material.

9. The secondary battery according to claim 8, wherein a ratio of a weight of the SiO to a total weight of the graphite and the SiO in the negative electrode active material is greater than or equal to 3 weight percent and less than or equal to 15 weight percent.

10. The secondary battery according to claim 1, wherein
the first electrode comprises a positive electrode, the first electrode current collector comprises a positive electrode current collector, the first electrode active material layer comprises a positive electrode active material layer, the first electrode current collector plate comprises a positive electrode current collector plate, the first electrode covered part comprises a positive electrode covered part, and the first electrode exposed part comprises a positive electrode exposed part; and
the second electrode comprises a negative electrode, the second electrode current collector comprises a negative electrode current collector, the second electrode active material layer comprises a negative electrode active material layer, the second electrode current collector plate comprises a negative electrode current collector plate, the second electrode covered part comprises a negative electrode covered part, and the second electrode exposed part comprises a negative electrode exposed part.

11. The secondary battery according to claim 10, wherein, in the positive electrode, the positive electrode current collector is covered with the positive electrode active material layer from an outer winding side edge of the positive electrode to an inner winding side edge of the positive electrode in a winding direction of the electrode wound body.

12. The secondary battery according to claim 1, wherein
the separator includes a porous film as a base, the porous film including polyolefin,
the porous film has a thickness greater than or equal to 10 micrometers and less than or equal to 15 micrometers, and
the porous film has a surface density greater than or equal to 6.3 grams per square meter and less than or equal to 8.3 grams per square meter.

13. The secondary battery according to claim 1, wherein the first electrode exposed part wound around the central axis includes first edge parts that are adjacent to each other in the radial direction of the electrode wound body, the first edge parts being bent toward the central axis to overlap each other.

14. The secondary battery according to claim 1, wherein the second electrode exposed part wound around the central axis includes second edge parts that are adjacent to each other in the radial direction of the electrode wound body, the second edge parts being bent toward the central axis to overlap each other.

15. The secondary battery according to claim 1, wherein the first electrode active material layer includes a positive electrode active material including at least one of lithium cobalt oxide, lithium nickel cobalt manganese oxide, or lithium nickel cobalt aluminum oxide.

16. A battery pack comprising:
the secondary battery according to claim 1;
a processor configured to control the secondary battery; and
an outer package body containing the secondary battery.

17. An electric vehicle comprising:
the secondary battery according to claim 1;
a converter configured to convert electric power suppled from the secondary battery into a driving force;
a drive unit configured to perform driving in accordance with the driving force; and
a processor configured to control operation of the secondary battery.

18. An electric aircraft comprising:
the battery pack according to claim 16;
a plurality of rotary wings;
a motor configured to rotate each of the rotary wings;
a support shaft supporting each of the rotary wings and the motor;
a motor control processor configured to control rotation of the motor; and
an electric power supply line configured to supply electric power to the motor,
wherein the battery pack is coupled to the electric power supply line.

19. An electric tool comprising:
the secondary battery according to claim 1; and
a movable part configured to receive electric power from the secondary battery.

20. Electronic equipment comprising
the secondary battery according to claim 1 as an electric power supply source.
